(19) United States
(12) Patent Application Publication
(10) Pub. No.: US 2026/0295439 A1
(43) Pub. Date: Oct. 1, 2026

(54) ONE OR MORE NON-TRANSITORY COMPUTER-READABLE STORAGE MEDIA, GAME SYSTEM, GAME APPARATUS AND COMPUTER-IMPLEMENTED METHOD

(71) Applicant: Nintendo Co., Ltd., Kyoto (JP)

(72) Inventors: Shoichi NOBUKIYO, Tokyo (JP); Masahiro SAKURAI, Tokyo (JP)

(21) Appl. No.: 19/566,630

(22) Filed: Mar. 13, 2026

(30) Foreign Application Priority Data
Mar. 25, 2025 (JP) 2025-049561

(51) Int. Cl. A63F 13/807; A63F 13/48; A63F 13/55; A63F 13/798

(52) U.S. Cl. CPC A63F 13/807; A63F 13/48; A63F 13/55; A63F 13/798

(57) ABSTRACT

When an instruction to board a rideable object being ridden by a first character is performed, the first character is caused to transition to a state of not riding the rideable object, and a second character is caused to board the rideable object.

### CROSS REFERENCE TO RELATED APPLICATION

This application claims priority to Japanese Patent Application No. 2025-49561 filed on Mar. 25, 2025, the entire contents of which are incorporated herein by reference.

FIELD

The present disclosure relates to information processing.

### BACKGROUND AND SUMMARY

Conventionally, there have been games in which a player character is caused to board a rideable object to play a competitive game.

However, there has been room for improvement regarding the manner in which the player character is caused to board the rideable object.

### Configuration Examples Will be Shown Below

### Configuration Example 1

A configuration example 1 is directed to one or more non-transitory computer-readable storage media having stored therein instructions that, when executed, cause one or more processors to perform operations including:
in response to a start instruction for a competitive game based on an operation input, sequentially executing a first game and a second game that is executed after end of the first game;
in the first game,
   moving, in a game stage, each participating character riding any of rideable objects having performance different by type among a plurality of participating characters participating in the competitive game, including a first participating character controlled based on an operation input, in a state of riding the rideable object,
   when a first boarding instruction with respect to a first rideable object not being ridden by any of the plurality of participating characters is performed based on an operation input, causing the first participating character to board the first rideable object, and when a second boarding instruction with respect to a second rideable object being ridden by a second participating character among the plurality of participating characters is performed based on an operation input, causing the second participating character to transition to a state of not riding the second rideable object, and causing the first participating character to board the second rideable object; and
in the second game,
   causing each participating character riding any of the rideable objects at the end of the first game, among the plurality of participating characters, to board a rideable object that had been ridden by said participating character at the end of the first game, and causing the plurality of participating characters to compete with each other.

### Configuration Example 2

In a configuration example 2 based on, for example, the above configuration example 1, the operations further include determining a win/loss or a ranking among the plurality of participating characters in the competitive game in accordance with a result of the second game.

### Configuration Example 3

In a configuration example 3 based on, for example, the above configuration example 1, the operations further include, in the first game, moving the plurality of participating characters in the game stage in which a rideable object not being ridden by any of the plurality of participating characters is placed.

### Configuration Example 4

In a configuration example 4 based on, for example, the above configuration example 3, the operations further include, in the first game, when the first participating character riding a third rideable object is caused to board the second rideable object being ridden by the second participating character in response to the second boarding instruction, placing the third rideable object in the game stage as a rideable object not being ridden by any of the plurality of participating characters.

### Configuration Example 5

In a configuration example 5 based on, for example, the above configuration example 4, the operations further include, in the first game, moving the first participating character not riding any of the rideable objects, based on an operation input.

### Configuration Example 6

In a configuration example 6 based on, for example, the above configuration example 5, the operations further include, in the first game, when the first participating character is caused to board the second rideable object being ridden by the second participating character in response to the second boarding instruction being performed, placing the second participating character, which had ridden the second rideable object, in the game stage in a state of not riding any of the rideable objects.

### Configuration Example 7

In a configuration example 7 based on, for example, the above configuration example 6, the operations further include, in the first game, when the first participating character riding the third rideable object is caused to board the second rideable object being ridden by the second participating character in response to the second boarding instruction being performed, placing the second participating character and the third rideable object in the game stage such that the third rideable object is located within a specified range based on a position of the second participating character.

### Configuration Example 8

In a configuration example 8 based on, for example, the above configuration example 1, the operations further include, in the first game: causing the first participating character to acquire an in-game item based on an operation input; determining a game parameter of the first participating character in accordance with the acquired in-game item and performance of a rideable object to be ridden by the first participating character; and performing control of the first participating character based on an operation input differently in accordance with the determined game parameter.

### Configuration Example 9

In a configuration example 9 based on, for example, the above configuration example 8, the operations further include, in the second game, controlling the first participating character based on the game parameter of the first participating character at the end of the first game.

### Configuration Example 10

In a configuration example 10 based on, for example, the above configuration example 8, the operations further include, in the first game, when the second boarding instruction to cause the first participating character to board the second rideable object being ridden by the second participating character is performed, causing the first participating character to board the second rideable object if a difference between a first game parameter of the first participating character and a second game parameter of the second participating character satisfies a specified condition.

### Configuration Example 11

In a configuration example 11 based on, for example, the above configuration example 10, the operations further include starting the first game in a state where each of the plurality of participating characters rides the rideable object of the same type.

### Configuration Example 12

In a configuration example 12 based on, for example, the above configuration example 1, the operations further include, in the first game, based on an operation input, causing the second participating character to transition to a state of not riding the second rideable object, based on an attack instruction against the second rideable object being ridden by the second participating character being performed, and updating the second rideable object to at least a state where the second participating character is unable to ride the second rideable object.

### Configuration Example 13

In a configuration example 13 based on, for example, the above configuration example 6 or 12, the operations further include, in the second game, causing each participating character that was not riding any of the rideable objects at the end of the first game, among the plurality of participating characters, to board the rideable object of a specified type.

### Configuration Example 14

In a configuration example 14 based on, for example, the above configuration example 1, the operations further include, in the second game, causing at least the participating characters that have specified a competitive format based on an operation input among a plurality of competitive formats, to compete with each other in the specified competitive format.

### Configuration Example 15

In a configuration example 15 based on, for example, the above configuration example 1, the operations further include: randomly determining a competitive format of the second game from among a plurality of competitive formats before the first game ends; presenting information indicating the determined competitive format of the second game, before the first game ends; and in the second game, causing the plurality of participating characters to compete with each other in the determined competitive format of the second game.

### Configuration Example 16

In a configuration example 16 based on, for example, the above configuration example 1, the operations further include, in the first game, when the first participating character is caused to board the second rideable object being ridden by the second participating character based on the second boarding instruction being performed, increasing a movement speed of the first participating character for a specified period after the first participating character is caused to board the second rideable object.

### Configuration Example 17

In a configuration example 17 based on, for example, the above configuration example 1, the operations further include, in the first game, when the first participating character is caused to board the second rideable object being ridden by the second participating character based on the second boarding instruction being performed, restricting, for a specified period after the first participating character is caused to board the second rideable object, the first participating character from being caused to transition to a state of not riding the second rideable object, not based on an operation input performed by a user for controlling the first participating character.

Each configuration example described above may be read as a configuration example of a game system, a game apparatus, or a computer-implemented method.

### BRIEF DESCRIPTION OF THE DRAWINGS

FIG. 1 shows a non-limiting example of a state where a left controller 3 and a right controller 4 are attached to a main body apparatus 2;

FIG. 2 is a block diagram showing a non-limiting example of the internal configuration of the main body apparatus 2;

FIG. 3 is a block diagram showing a non-limiting example of the internal configurations of the main body apparatus 2, the left controller 3, and the right controller 4;

FIG. 4 illustrates a non-limiting example of a game screen;

FIG. 5 illustrates a non-limiting example of a game screen;

FIG. 6 illustrates a non-limiting example of actual performance values in a state where a player character is riding a machine;

FIG. 7 illustrates a non-limiting example of a game screen;

FIG. 8 illustrates a non-limiting example of a game screen;

FIG. 9 illustrates a non-limiting example of a game screen;

FIG. 10 illustrates a non-limiting example of a game screen;

FIG. 11 illustrates a non-limiting example of an imaging direction of a virtual camera at the time of machine capture;

FIG. 12 illustrates a non-limiting example of actual performance values of durability when a character riding a machine is changed;

FIG. 13 illustrates a non-limiting example of a game screen;

FIG. 14 illustrates a non-limiting example of a game screen;

FIG. 15 illustrates a non-limiting example of various data stored in a DRAM 85;

FIG. 16 is a non-limiting example of a flowchart of game processing;

FIG. 17 is a non-limiting example of a flowchart of game processing;

FIG. 18 is a non-limiting example of a flowchart of game processing;

FIG. 19 is a non-limiting example of a flowchart of game processing;

FIG. 20 is a non-limiting example of a flowchart of game processing;

FIG. 21 is a non-limiting example of a flowchart of game processing;

FIG. 22 is a non-limiting example of a flowchart of game processing; and

FIG. 23 illustrates a non-limiting example of a game screen.

### DETAILED DESCRIPTION OF NON-LIMITING EXAMPLE EMBODIMENTS

Hereinafter, an exemplary embodiment will be described.

### Hardware Configuration of Information Processing System

Hereinafter, an information processing system (game system, game apparatus) according to an example of the exemplary embodiment will be described below. An example of a game system 1 according to the exemplary embodiment includes a main body apparatus (an information processing apparatus, which functions as a game apparatus main body in the exemplary embodiment) 2, a left controller 3, and a right controller 4. Each of the left controller 3 and the right controller 4 is attachable to and detachable from the main body apparatus 2. That is, the game system 1 can be used as a unified apparatus obtained by attaching each of the left controller 3 and the right controller 4 to the main body apparatus 2. Further, in the game system 1, the main body apparatus 2, the left controller 3, and the right controller 4 can also be used as separate bodies. Hereinafter, first, the hardware configuration of the game system 1 according to the exemplary embodiment will be described, and then, the control of the game system 1 according to the exemplary embodiment will be described.

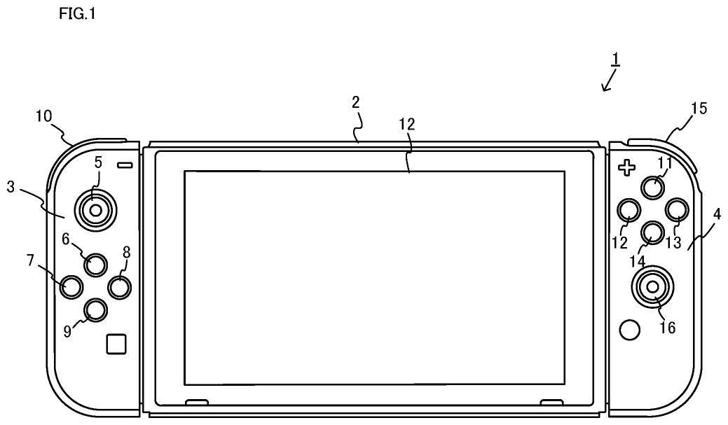

FIG. 1 shows an example of the state where the left controller 3 and the right controller 4 are attached to the main body apparatus 2. As shown in FIG. 1, each of the left controller 3 and the right controller 4 is attached to and unified with the main body apparatus 2. The main body apparatus 2 is an apparatus for performing various processes in the game system 1. The main body apparatus 2 includes a display 12. Each of the left controller 3 and the right controller 4 is an apparatus including operation sections with which a user provides inputs.

In addition, the main body apparatus 2 includes a speaker, and a sound such as a sound effect is outputted from the speaker.

Further, the main body apparatus 2 includes a left terminal for the main body apparatus 2 to perform wired communication with the left controller 3, and a right terminal for the main body apparatus 2 to perform wired communication with the right controller 4.

Further, the main body apparatus 2 includes a slot. The slot is provided at an upper side surface of a housing of the main body apparatus 2. The slot is so shaped as to allow a specified type of storage medium to be attached to the slot. The specified type of storage medium is, for example, a dedicated storage medium (e.g., a dedicated memory card) for the game system 1 and an information processing apparatus of the same type as the game system 1. The specified type of storage medium is used to store, for example, data (e.g., saved data of an application or the like) used by the main body apparatus 2 and/or a program (e.g., a program for an application or the like) executed by the main body apparatus 2.

The left controller 3 and the right controller 4 each include various operation buttons and the like. For example, the left controller 3 includes buttons 6 to 10 and a left stick 5, which is a directional input device. For example, the right controller 4 includes buttons 11 to 15 and a right stick 16, which is a directional input device. The various operation buttons and the like are used to give instructions depending on various programs (e.g., an OS program and an application program) executed by the main body apparatus 2.

In addition, the left controller 3 and the right controller 4 each include a terminal for performing wired communication with the main body apparatus 2.

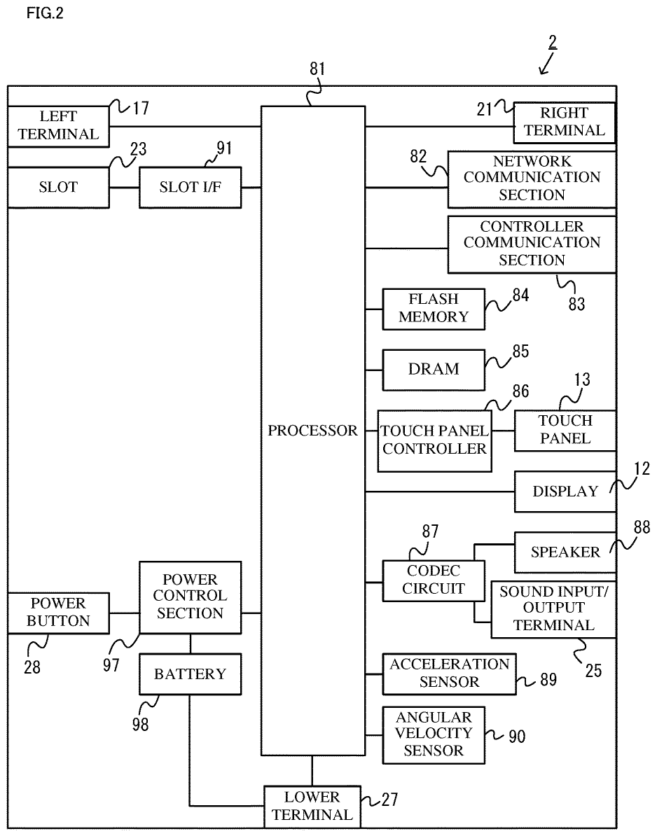

FIG. 2 is a block diagram showing an example of the internal configuration of the main body apparatus 2. The main body apparatus 2 includes a processor 81. The processor 81 is an information processing section for executing various types of information processing to be executed by the main body apparatus 2. For example, the processor 81 may be composed of a plurality of processors or cores, typically, a plurality of CPUs (Central Processing Units) or cores, or may be composed of a SoC (System-on-a-chip) having a plurality of functions such as a CPU function and a GPU (Graphics Processing Unit) function. The processor 81 executes an information processing program (e.g., a game program) stored in a storage section (specifically, an internal storage medium such as a flash memory 84, an external storage medium attached to the slot 23, or the like), thereby performing the various types of information processing. The above information processing program includes computer-executable instructions. In the exemplary embodiment, the term “processor” may include at least a CPU, a GPU, an ASIC (Application Specific Integrated Circuit), an FPGA (Field Programmable Gate Array), and the like. In addition, in the exemplary embodiment, the term “computer” refers to one that includes at least one processor, as an example, and may further include a storage section such as at least one memory.

The main body apparatus 2 includes the flash memory 84 and a DRAM (Dynamic Random Access Memory) 85 as examples of internal storage media built into the main body apparatus 2. The flash memory 84 and the DRAM 85 are connected to the processor 81. The flash memory 84 is a memory mainly used to store various data (or programs) to be saved in the main body apparatus 2. The DRAM 85 is a memory used to temporarily store various data used for information processing. As each of these memories, a plurality of memories may be provided.

The main body apparatus 2 includes a slot interface (hereinafter, abbreviated as “I/F”) 91. The slot I/F 91 is connected to the processor 81. The slot I/F 91 is connected to the slot 23, and in accordance with an instruction from the processor 81, reads and writes data from and to the specified type of storage medium (e.g., a dedicated memory card) attached to the slot 23.

The processor 81 appropriately reads and writes data from and to the flash memory 84, the DRAM 85, and each of the above storage media, thereby performing the above information processing.

The main body apparatus 2 includes a network communication section 82. The network communication section 82 is connected to the processor 81. The network communication section 82 communicates (for example, through wireless communication) with an external apparatus via a network. In the exemplary embodiment, the network communication section 82 connects to a wireless LAN by a method compliant with the Wi-Fi standard, for example, and performs Internet communication or the like with an external apparatus (another main body apparatus 2). Further, the network communication section 82 can also perform short-range wireless communication (e.g., infrared light communication) with another main body apparatus 2.

The main body apparatus 2 includes a controller communication section 83. The controller communication section 83 is connected to the processor 81. The controller communication section 83 wirelessly communicates with the left controller 3 and/or the right controller 4. The communication method between the main body apparatus 2, and the left controller 3 and the right controller 4, is discretionary. In the exemplary embodiment, the controller communication section 83 performs communication compliant with the Bluetooth (registered trademark) standard with the left controller 3 and with the right controller 4.

The processor 81 is connected to the left terminal 17, the right terminal 21, and the lower terminal 27. When performing wired communication with the left controller 3, the processor 81 transmits data to the left controller 3 via the left terminal 17 and also receives operation input data from the left controller 3 via the left terminal 17. Further, when performing wired communication with the right controller 4, the processor 81 transmits data to the right controller 4 via the right terminal 21 and also receives operation input data from the right controller 4 via the right terminal 21. Further, when communicating with the cradle, the processor 81 transmits data to the cradle via the lower terminal 27. As described above, in the exemplary embodiment, the main body apparatus 2 can perform both wired communication and wireless communication with each of the left controller 3 and the right controller 4. Further, when the unified apparatus obtained by attaching the left controller 3 and the right controller 4 to the main body apparatus 2 or the main body apparatus 2 alone is attached to the cradle, the main body apparatus 2 can output data (e.g., image data or sound data) to the stationary monitor or the like via the cradle.

The main body apparatus 2 includes a touch panel controller 86, which is a circuit for controlling the touch panel 13. The touch panel controller 86 is connected between the touch panel 13 and the processor 81. On the basis of a signal from the touch panel 13, the touch panel controller 86 generates data indicating the position at which a touch input has been performed, for example, and outputs the data to the processor 81.

Further, the display 12 is connected to the processor 81. The processor 81 displays a generated image (e.g., an image generated by executing the above information processing) and/or an externally acquired image on the display 12.

The main body apparatus 2 includes a codec circuit 87 and speakers (specifically, a left speaker and a right speaker) 88. The codec circuit 87 is connected to the speakers 88 and a sound input/output terminal 25 and also connected to the processor 81. The codec circuit 87 is a circuit for controlling the input and output of sound data to and from the speakers 88 and the sound input/output terminal 25.

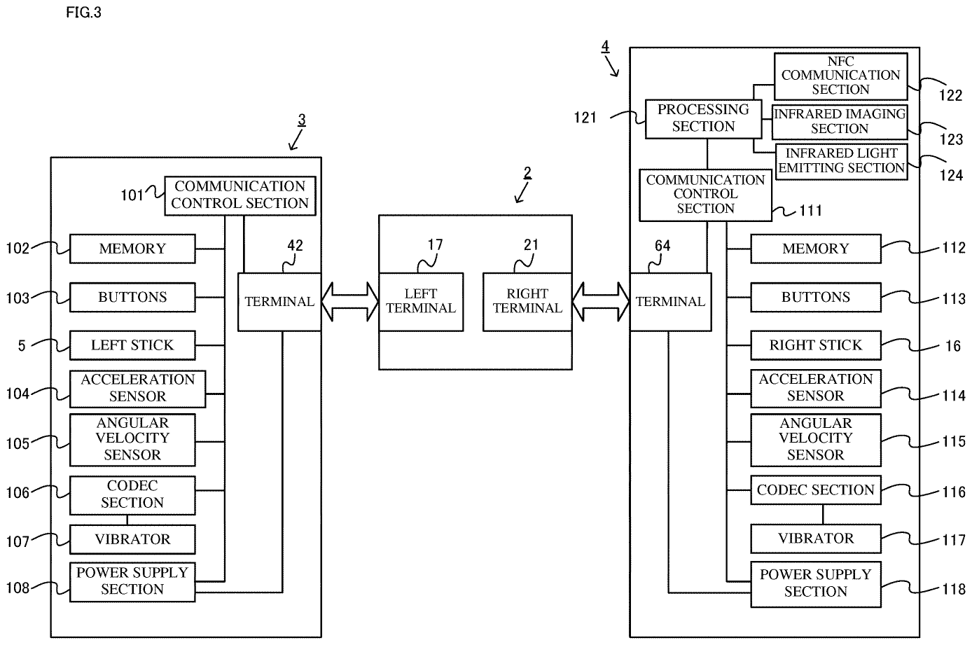

FIG. 3 is a block diagram showing examples of the internal configurations of the main body apparatus 2, the left controller 3, and the right controller 4. The details of the internal configuration of the main body apparatus 2 are shown in FIG. 2 and therefore are omitted in FIG. 3.

The left controller 3 includes a communication control section 101, which communicates with the main body apparatus 2. As shown in FIG. 3, the communication control section 101 is connected to components including the terminal 42. In the exemplary embodiment, the communication control section 101 can communicate with the main body apparatus 2 through both wired communication via the terminal 42 and wireless communication not via the terminal 42. The communication control section 101 controls the method for communication performed by the left controller 3 with the main body apparatus 2. That is, when the left controller 3 is attached to the main body apparatus 2, the communication control section 101 communicates with the main body apparatus 2 via the terminal 42. Further, when the left controller 3 is detached from the main body apparatus 2, the communication control section 101 wirelessly communicates with the main body apparatus 2 (specifically, the controller communication section 83). The wireless communication between the communication control section 101 and the controller communication section 83 is performed in accordance with the Bluetooth (registered trademark) standard, for example.

Further, the left controller 3 includes a memory 102 such as a flash memory. The communication control section 101 includes, for example, a microcomputer (or a microprocessor) and executes firmware stored in the memory 102, thereby performing various processes.

The left controller 3 includes buttons 103 (6 to 10 in FIG. 1). Further, the left controller 3 includes the left stick 5. Each of the buttons 103 and the left stick 5 outputs information regarding an operation performed on itself to the communication control section 101 repeatedly at appropriate timings.

The left controller 3 includes inertial sensors. Specifically, the left controller 3 includes an acceleration sensor 104 and an angular velocity sensor 105.

The communication control section 101 acquires information regarding an input (specifically, information regarding an operation or the detection result of the sensor) from each of input sections (specifically, the buttons 103, the left stick 5, and the sensors 104 and 105). The communication control section 101 transmits operation input data including the acquired information (or information obtained by performing specified processing on the acquired information) to the main body apparatus 2. The operation input data is transmitted repeatedly, once every specified time.

The above operation input data is transmitted to the main body apparatus 2, whereby the main body apparatus 2 can obtain inputs provided to the left controller 3. That is, the main body apparatus 2 can determine operations on the buttons 103 and the left stick 5 on the basis of the operation input data. Further, the main body apparatus 2 can calculate information regarding the motion and/or the orientation of the left controller 3 on the basis of the operation input data (specifically, the detection results of the acceleration sensor 104 and the angular velocity sensor 105).

As shown in FIG. 3, the right controller 4 includes a communication control section 111, which communicates with the main body apparatus 2. Further, the right controller 4 includes a memory 112, which is connected to the communication control section 111. The communication control section 111 is connected to components including the terminal 64. The communication control section 111 and the memory 112 have functions similar to those of the communication control section 101 and the memory 102, respectively, of the left controller 3. Thus, the communication control section 111 can communicate with the main body apparatus 2 through both wired communication via the terminal 64 and wireless communication not via the terminal 64 (specifically, communication compliant with the Bluetooth (registered trademark) standard). The communication control section 111 controls the method for communication performed by the right controller 4 with the main body apparatus 2.

The right controller 4 includes input sections similar to the input sections of the left controller 3. Specifically, the right controller 4 includes buttons 113 (11 to 15 in FIG. 1), the right stick 16 and inertial sensors (an acceleration sensor 114 and an angular velocity sensor 115). These input sections have functions similar to those of the input sections of the left controller 3 and operate similarly to the input sections of the left controller 3.

The main body apparatus 2 can also communicate with controllers other than the left controller 3 and the right controller 4 described above (another left controller 3 and another right controller 4), and the processor 81 can perform game processing, etc., based on operation input data received from many controllers. That is, many controllers can be connected to the main body apparatus 2, and a multiplayer game or the like can be played by a plurality of users using the one main body apparatus 2. In addition, the main body apparatus 2 can also communicate with one or more other main body apparatuses 2, and a multiplayer game or the like can be played by a plurality of users. Further, a plurality of users can play a multiplayer game or the like in a mode in which the above-described modes are combined. In the following, a case where a multiplayer game is played by players using respective main body apparatuses 2 will be described as an example.

### Game Assumed in Exemplary Embodiment

The game assumed in the exemplary embodiment is, as an example, a multiplayer game in which 2 to 16 players can play simultaneously, and in which a first game and a second game are sequentially executed in response to an instruction to start a competitive game. The second game does not necessarily need to be executed immediately after the first game, and another game may be executed between the first game and the second game. Further, the first game and the second game may be switched seamlessly.

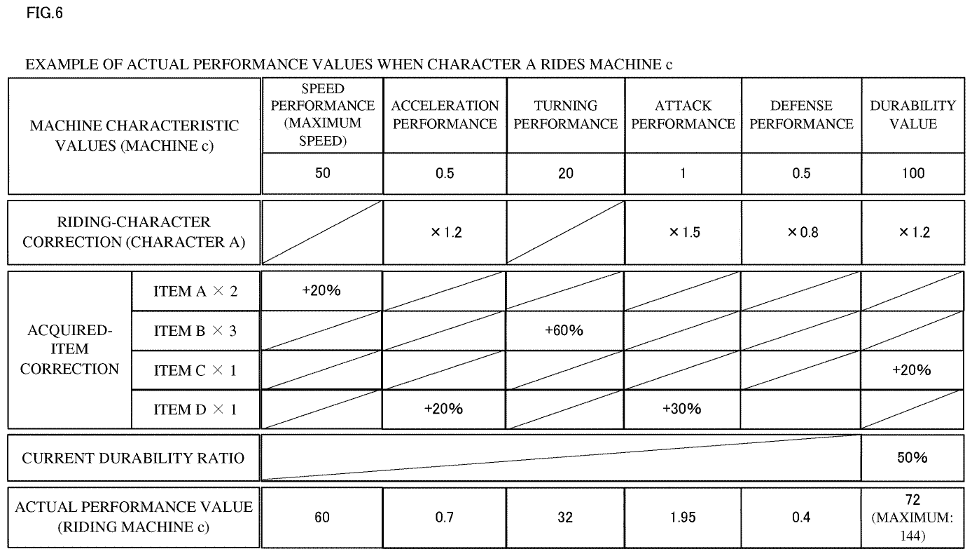

The first game is, for example, a game that ends upon the elapse of a specified time (for example, 5 minutes). In the game stage of the first game, for example, each player moves a player character (sometimes simply referred to as “character”) riding a machine (rideable object for the player). In the first game, each player moves the character riding the machine and causes the character to acquire items placed in the game stage, thereby improving actual performance values in a state where the character is riding the machine (parameter values, in a character-riding state, of “speed performance”, “acceleration performance”, “turning performance”, “attack performance”, “defense performance”, and “durability”, which will be described later with reference to FIG. 6, and which are sometimes simply referred to as “actual performance values”). Further, there are a plurality of types of machines, and “machine characteristic values,” which will be described later, differ depending on the type of machine. The actual performance values may include other types of performance such as flight performance for flying in the air. In addition, each machine may have different characteristics. For example, when a character boards a specific machine type, a specified action corresponding to that machine type may be enabled. Further, for example, the first game may end when the total number of items acquired by all participating players reaches a specified number (or a specified proportion of the total number of items), or when a specific item is acquired by a player, or the first game may end in response to an end instruction performed by a player.

Further, in the first game, each player can operate their own player character (sometimes referred to as “own character”) to cause the player character to board a machine placed in the game stage, to switch to another machine, or to capture a machine being ridden by another player character (sometimes referred to as “other character”) and switch to that machine. Acquired items are associated with the character. Thus, when the character switches machines, the actual performance values after the switch are determined in accordance with the acquired items. Further, as will be described later with reference to FIG. 6, the type of character also affects the actual performance values.

The second game is a game that is started in a state where each character is riding the machine that had been ridden by the character at the end of the first game, and in the second game, each character cannot switch machines. Further, at the start of the second game, the actual performance values at the end of the first game are carried over. There are a plurality of types of second games (four types in the exemplary embodiment), and the actual performance values that are important differ depending on the type of the second game to be played. For example, when participating in a race-type competitive game among the second games, having, for example, a high speed performance is advantageous. For example, when participating in a battle-type competitive game among the second games, having, for example, a high attack performance is advantageous. The result of the second game (for example, a win/loss or a ranking) is the result of this competitive game. The game stage of the first game and the game stage of the second game may be the same.

Thus, each player acquires items and switches machines in the first game so as to build desired actual performance values in order to be able to play advantageously in the second game in which the player participates. The characters participating in this competitive game may include non-player characters operated by the processor 81.

### Outline of Game Processing of Exemplary Embodiment

First, at the start (or before the start) of the competitive game of the exemplary embodiment, each player selects their own character from among a plurality of characters. There is only one type of the first game, and all characters participating in this competitive game participate in the first game. The second games include, for example, a first race game in which characters hardly attack each other and which has many straight sections (a second game in which “speed performance” is particularly important), a second race game in which characters hardly attack each other and which has few straight sections (a second game in which “acceleration performance” and “turning performance” are particularly important), a first battle game in which characters attack each other and defeat opponents in a complicated maze (a second game in which “attack performance”, “defense performance”, and “durability” are particularly important), and a second battle game in which characters attack each other and defeat opponents on a plain with few obstacles (a second game in which all performances are important). Further, in the exemplary embodiment, after the end of the first game, each player selects the type of the second game to participate in (sometime referred to as “competitive format”). Before the end of the first game, each player may select the type of the second game to participate in. Further, the number of types of second games may be only one, may be two or three, or may be more than four.

### First Game

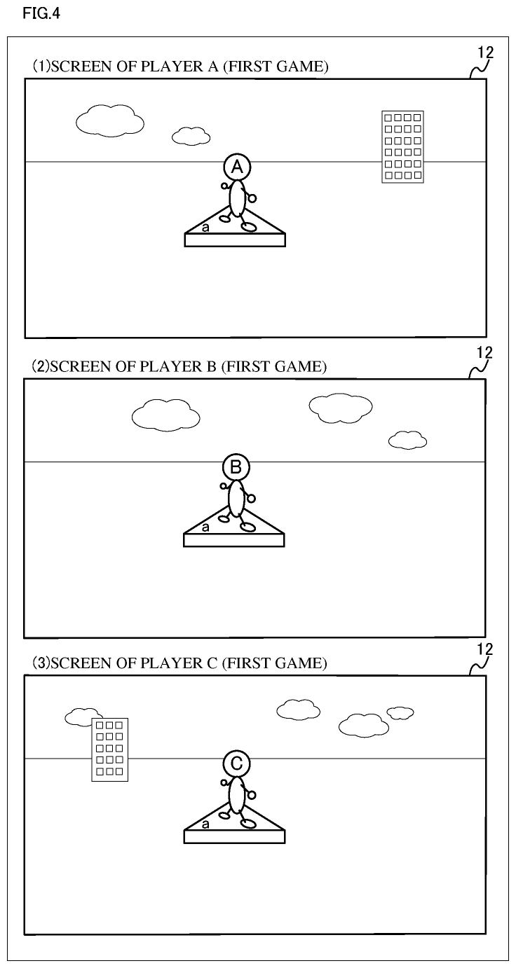

FIG. 4 illustrates an example of images displayed on the displays 12 of the players at the start of the first game. As shown in FIG. 4, when the first game is started, the own character riding one type of machine determined in advance in the game stage of the first game (in the exemplary embodiment, a machine a) is displayed on the display 12 of each player. That is, all characters ride the same type of machines a, and the first game starts. In FIG. 4(1) to (3), the display of a player A shows a character A (character operated by the player A) riding the machine a, the display of a player B shows a character B (character operated by the player B) riding the machine a, and the display of a player C shows a character C (character operated by the player C) riding the machine a.

In the first game, player characters can ride a large number of machines placed in the game stage (for example, 20 types of machines). As will be described later with reference to FIG. 6, “machine characteristic values” are preset for each machine, and the machine characteristic values are corrected in accordance with the type of the riding character and the items acquired by the riding character, thereby determining actual performance values. The machine a, which is ridden by each character at the start of the first game, has machine characteristic values that are set generally lower than those of other types of machines. Therefore, in the first game, each player plays by acquiring items and switching to other machines so as to gain an advantage in the second game.

In the first game, each player can operate the own character to move the own character in a state of riding a machine, and can also move the own character in a state where the own character is not riding a machine (that is, in an on-foot state). Further, in the first game, each character can move significantly faster in a state of riding a machine than in an on-foot state.

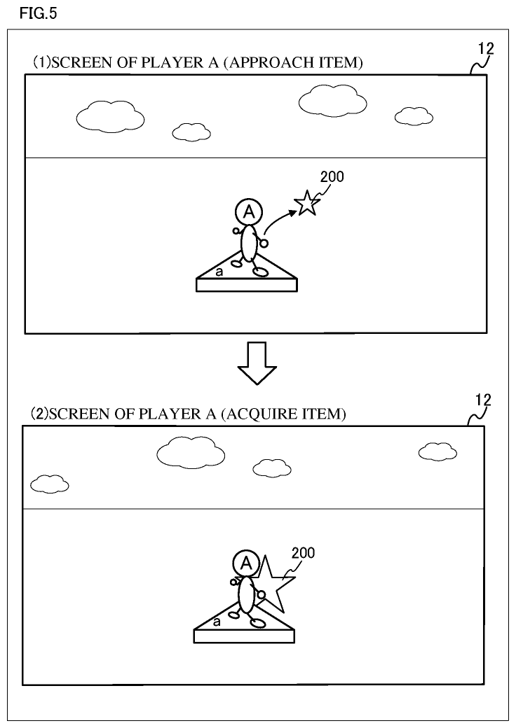

FIG. 5 illustrates a scene in which a character riding a machine acquires an item in the first game. In the first game, each character can acquire items in a state of riding a machine, but cannot acquire items in an on-foot state. When, in response to an operation performed by the player, the character moves toward an item in a state of riding the machine a shown in FIG. 5(1), and the character enters a specified range of the item (for example, within a range of 0.5 m from the item in a virtual space) as shown in FIG. 5(2), the character acquires the item. In FIG. 5, the character A riding the machine a enters a specified range of an item 200 and acquires the item 200. When an acquisition instruction (for example, an operation on a specified button) is performed by the player in a state where the character riding the machine is within a specified range of an item, the character may acquire the item. Further, when a hit determination (collision) occurs between a character riding a machine (or a machine ridden by a character) and an item, the item may be acquired.

An acquired item is deleted from the game stage and cannot be acquired by any character thereafter. The acquired item may be hidden only on the screen of the player who operates the character that has acquired the item, such that the item cannot be acquired again by that character, and may be displayed on the screens of the other players.

FIG. 6 illustrates actual performance values in a state where a character is riding a machine. In FIG. 6, as an example, a case where the character A is riding a machine c is shown.

For each machine, “machine characteristic values” indicating characteristics of the machine itself are preset. The machine characteristic values are values inherent to the machine. The machine characteristic values include speed performance that defines a maximum speed, acceleration performance that defines acceleration force, turning performance that defines turning force, attack performance that defines attack power, defense performance that defines defense power, and durability that defines durability strength. The machine characteristic values are fixed values. In FIG. 6, as the characteristic values of the machine c, speed performance 50, acceleration performance 0.5, turning performance 20, attack performance 1, defense performance 0.5, and durability 100 are shown.

With respect to the machine characteristic values, correction corresponding to the type of the character riding the machine (riding-character correction) is performed. In FIG. 6, riding-character correction corresponding to the riding character A is performed. Specifically, as shown in FIG. 6, the acceleration performance is multiplied by 1.2, the attack performance is multiplied by 1.5, the defense performance is multiplied by 0.8, and the durability is multiplied by 1.2.

Thereafter, with respect to the machine characteristic values that have undergone the riding-character correction, correction corresponding to items acquired by the character riding the machine (acquired-item correction) is performed. In FIG. 6, the acquired-item correction corresponding to items acquired by the character A is performed. Specifically, as shown in FIG. 6, since two items A that each increase the speed performance by 10% have been acquired, the speed performance is increased by 20%; since three items B that each increase the turning performance by 20% have been acquired, the turning performance is increased by 60%; since one item C that increases the durability by 20% has been acquired, the durability is increased by 20%; and since one item D that increases the acceleration performance by 20% and increases the attack performance by 30% has been acquired, the acceleration performance is increased by 20% and the attack performance is increased by 30%.

As described above, by performing the riding-character correction and then performing the acquired-item correction on the machine characteristic values, the actual performance values are determined. In FIG. 6, as the actual performance values in a case where the character A is riding the machine c, the speed performance is 60, the acceleration performance is 0.7, the turning performance is 32, the attack performance is 1.95, and the defense performance is 0.4.

Here, the actual performance value of durability decreases due to being attacked or the like. In FIG. 6, the actual performance value of durability has decreased by 72 from a maximum value of 144, resulting in a value of 72. Further, as shown in FIG. 6, a ratio of the actual performance value of durability to the maximum value (current durability ratio) is calculated. In FIG. 6, a current durability ratio of 50% is calculated. When the actual performance value of durability becomes 0 (zero) (or less than 0), the machine is destroyed and no character can ride the machine. In addition, the higher the attack performance is, the more the actual performance value of durability of an attacked opponent can be reduced, and the higher the defense performance is, the more a decrease in the actual performance value of durability can be suppressed when being attacked.

In FIG. 6, decimal places of the actual performance values are not shown. The acquired-item correction may be performed on the machine characteristic values before the riding-character correction is performed. Further, in the riding-character correction and/or the acquired-item correction, instead of correcting the machine characteristic values by multiplying the machine characteristic values by specified factors, the correction may be performed by adding (or subtracting) constants. For example, there may be an item that adds 10 (a specified constant) to the speed performance value among the machine characteristic values each time the item is acquired. Further, there may be an item that decreases a machine characteristic value by multiplying the machine characteristic value by a specified factor.

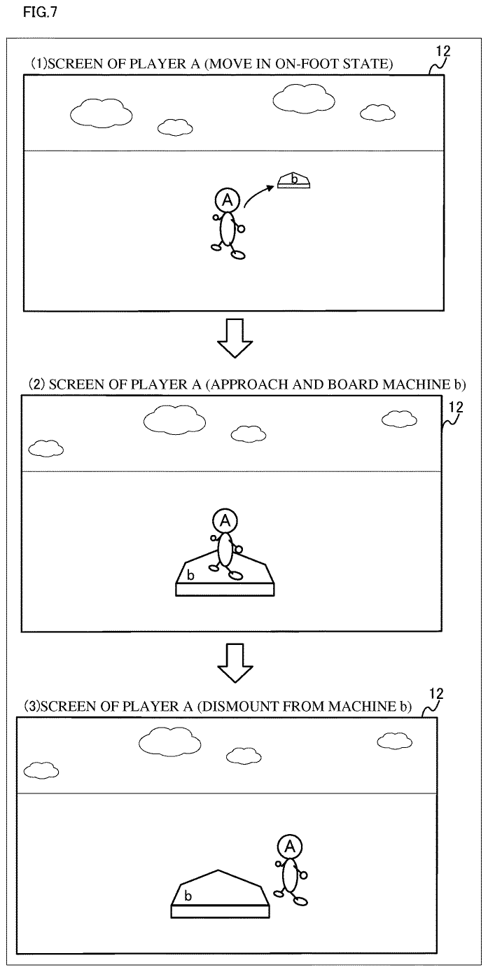

FIG. 7 illustrates scenes in which, in the first game in response to an operation performed by a player, a character is moved in an on-foot state, the character in the on-foot state is caused to board a machine that is not being ridden by any character (sometimes referred to as “empty machine”), and the character riding the machine is caused to dismount from the machine and transition to an on-foot state. For example, when, in response to a specified operation performed by the player A, the character A moves on foot toward a machine b (see FIG. 7(1)) and comes into contact with the machine b, the character A boards the machine b (see FIG. 7(2)). That is, in response to a boarding instruction for the empty machine b, the character A is caused to board the empty machine b. Further, for example, in response to a specified operation performed by the player A, the character A dismounts from the machine b and transitions to an on-foot state (see FIG. 7(3)).

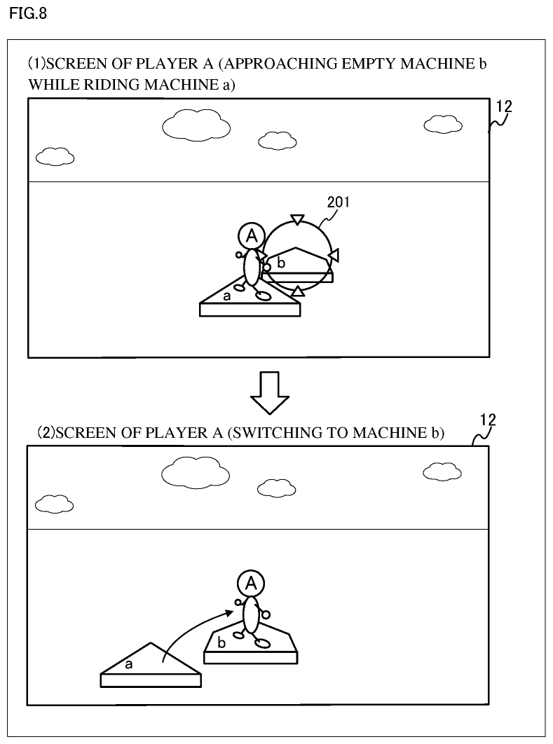

FIG. 8 illustrates a scene in which, in the first game, a character riding a machine switches to another empty machine without transitioning to an on-foot state. In the first game, each character riding a machine can directly switch to an empty machine without transitioning to an on-foot state. For example, when, in response to a movement operation performed by the player, the character A riding the machine a moves toward the empty machine b and enters a specified range of the empty machine b (for example, within a range of 4 m from the empty machine b in the virtual space), a lock-on cursor 201 is displayed (see FIG. 8(1)). While the lock-on cursor 201 is displayed, in accordance with the machine a coming into contact with the machine b in response to a specified operation performed by the player A (for example, an operation for moving the machine a while pressing a specified button for one second or longer), the character A jumps from the machine a to the machine b to switch to the machine b (see FIG. 8(2)). In this case, the machine a that had been ridden by the character A is placed in the stage as an empty machine (see FIG. 8(2)).

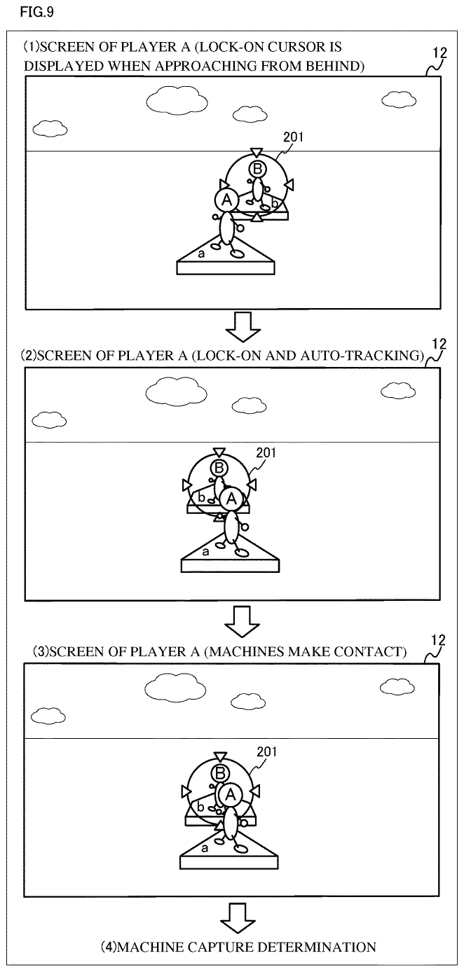

FIG. 9 to FIG. 11 illustrate scenes in which, in the first game, a character riding a machine attempts to capture a machine being ridden by another character and succeeds or fails in capturing the machine. Hereinafter, a case where the character A operated by the player A (character A riding the machine a) attempts to capture the machine b being ridden by the character B operated by the player B (character B riding the machine b) will be described as an example.

First, when, in response to a movement operation performed by the player A, the character A riding the machine a approaches from behind the character B riding the machine b (for example, the character A is positioned within a range of 20° or less in any of the vertical, horizontal, left, and right directions from a position directly behind the machine b and within a specified distance from the machine b (for example, within 10 m in the virtual space)), the lock-on cursor 201 is displayed on the character B (see FIG. 9(1)).

Then, while the lock-on cursor 201 is displayed, when the player A performs a specified operation (for example, presses a specified button for 2 seconds or longer), a lock-on state is established with respect to the character B riding the machine b, and the character A riding the machine a transitions to a state of automatically tracking the character B riding the machine b (see FIG. 9(2)). The automatic tracking is canceled when the player A performs a specified operation.

Then, when the machine a catches up to and comes into contact with the machine b while in the automatic tracking state (see FIG. 9(3)), a machine capture determination for determining whether or not the character A can capture the machine from the character B is executed (see FIG. 9(4)). During the automatic tracking, the speed performance, etc., (see FIG. 6) of the tracking machine a are improved. This makes it possible to avoid a situation in which the machine a cannot catch up with the machine b due to a relationship between the speed performance of the character A riding the machine a and the speed performance of the character B riding the machine b.

The machine capture determination is performed, for example, based on a comparison (difference) between the actual performance values of the capturing side and the actual performance values of the side to be captured (see FIG. 6). For example, when the actual performance value of durability of the capturing side is higher than that of the side to be captured by, for example, 20 or more, the machine capture is determined to be successful, and otherwise the machine capture is determined to fail. For example, when the actual performance value of attack performance of the capturing side is higher than the actual performance value of defense performance of the side to be captured, the machine capture is determined to be successful, and otherwise the machine capture is determined to fail. For example, when the current durability ratio of the side to be captured is lower than 30% and the actual performance value of attack performance of the capturing side is higher than the actual performance value of defense performance of the side to be captured, the machine capture is determined to be successful, and otherwise the machine capture is determined to fail. The machine capture determination may be performed based not on the actual performance values or the current durability ratio as described above, but on values on which riding-character correction and/or acquired-item correction is not performed (see FIG. 6).

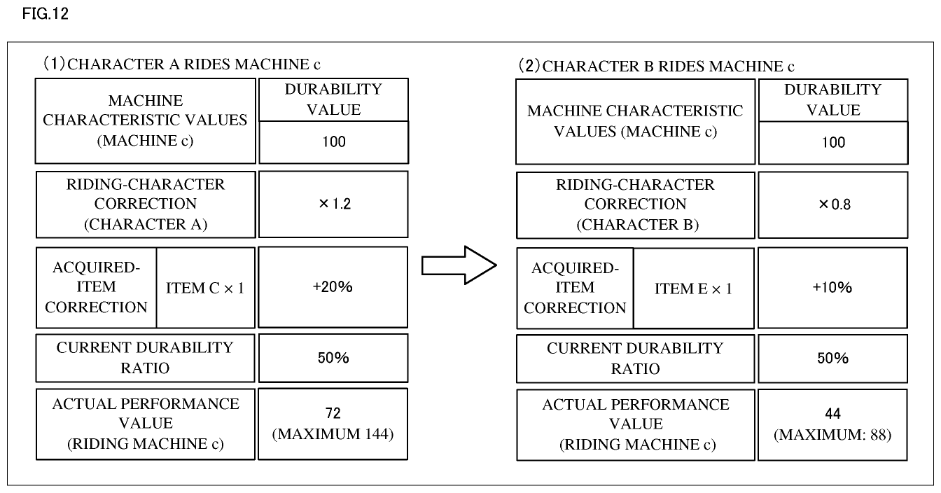

Here, with reference to FIG. 12, a change in the actual performance value of durability in a case where machine capture is successful and the character riding the machine is replaced, will be described. When the character riding the machine is replaced, the current durability ratio immediately before the replacement is carried over as the current durability ratio after the replacement. Then, based on the carried-over current durability ratio, etc., the actual performance value of durability is calculated. FIG. 12 illustrates, as an example, a change in the actual performance value of durability in a case where the character B riding another machine captures the machine c from the character A riding the machine c. FIG. 12(1) illustrates a state where the character A is riding the machine c, which is the same state as that shown in FIG. 6, and FIG. 12(2) illustrates a state where the character B captures the machine c and rides the machine c. Further, in FIG. 12, values other than durability are omitted. When the character B captures the machine c that had been ridden by the character A, as shown in FIG. 12(2), the current durability ratio of 50% is carried over, and an actual performance value of durability of 44 for the machine c in the state of being ridden by the character B is calculated. Here, in FIG. 12(2), riding-character correction (×0.8) for the character B and acquired-item correction (+10%) due to the character B acquiring one item E are executed, thereby calculating a maximum actual performance value of durability of 88. When a machine is captured, instead of carrying over the current durability ratio, the current durability ratio may be recovered to 100% (or to a specified percentage).

Further, for the parameters other than durability, reference is not made to the actual performance values immediately before the replacement. However, in another exemplary embodiment, for the parameters other than durability, reference may be made to the actual performance values immediately before the replacement.

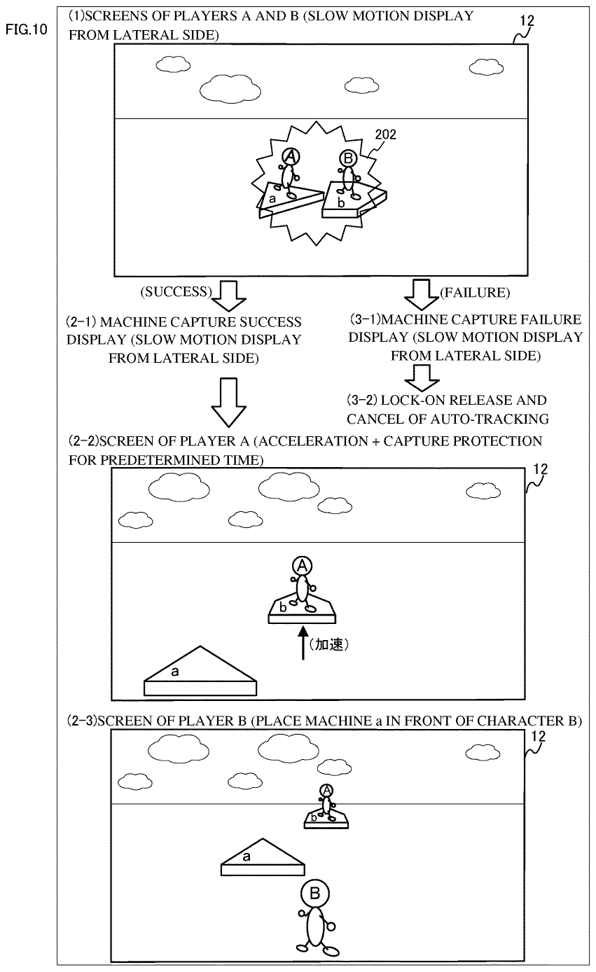

When the machine capture determination is executed, a slow-motion image showing, from a lateral viewpoint, a scene in which the character A attempts to capture the machine b is displayed for a specified period (for example, one second) on the screens of the player A (the capturing side) and the player B (the side to be captured), and an effect image 202 is also displayed (see FIG. 10(1)).

Thereafter, if it is determined to be a failure in the machine capture determination, a slow-motion image showing, from a lateral viewpoint, a scene in which the character A fails to jump onto the machine b is displayed on the screens of the player A and the player B (see FIG. 10(3-1)). Then, the lock-on with respect to the character B riding the machine b is released, and the auto-tracking is canceled (see FIG. 10(3-2)). When it is determined to be a failure in the machine capture determination, the above slow-motion image may not necessarily be displayed.

On the other hand, if it is determined to be a success in the machine capture determination, a slow-motion image showing, from a lateral viewpoint, a scene in which the character A jumps onto and boards the machine b is displayed on the screens of the player A and the player B (see FIG. 10(2-1)). In this scene, the character B from which the machine b is captured is thrown off the machine B. As described above, in response to a boarding instruction with respect to a machine being ridden by another character (which may also be regarded as a boarding instruction with respect to another character), that machine can be captured.

Further, when the above machine capture is displayed in slow motion, only the screens of the player capturing the machine and the player from which the machine is being captured (see FIG. 10(1), (2-1), and (3-1)) are shown in slow motion, while the screens of the other players are not shown in slow motion. When this slow-motion display is performed, the time-progress speed of each object in the virtual space is not changed, for example.

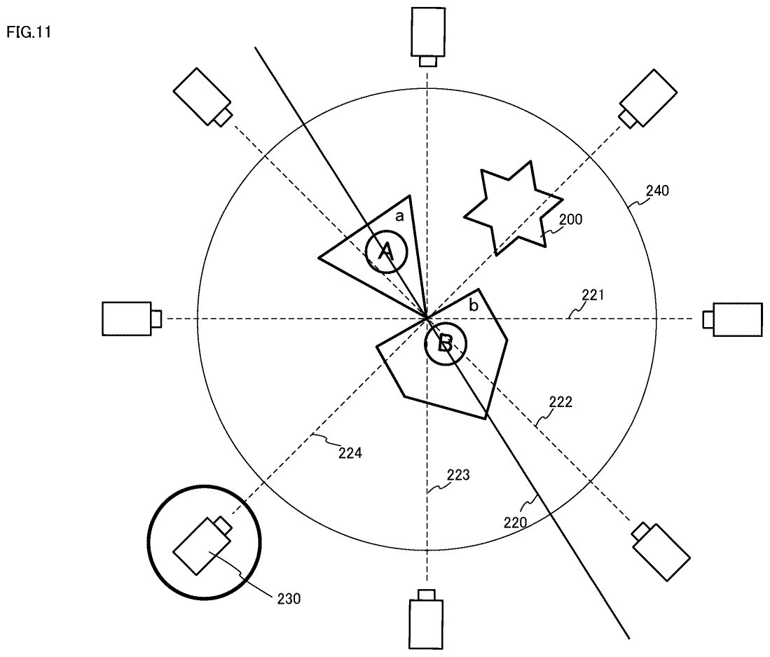

FIG. 11 illustrates the angle of a virtual camera in the virtual space used to capture the above-described scene in which machine capture is attempted and succeeds or fails (scene displayed in slow motion from a lateral viewpoint). FIG. 11 is a top view of the virtual space in which the character A attempts to capture the machine b being ridden by the character B and either succeeds or fails, as described with reference to FIG. 10(1), (2-1), and (3-1). In FIG. 11, a straight line 220 is, for example, a straight line passing through the center (or center of gravity) of the machine a and the center (or center of gravity) of the machine b. Broken lines 221, 222, 223, and 224 are, for example, straight lines that pass through the midpoint between the center of the machine a and the center of the machine b and that divide a circle 240 centered at this midpoint into eight equal sections.

As shown in FIG. 11, both ends of each of the broken lines 221, 222, 223, and 224 are positions of candidates (sometimes referred to as “candidate positions”) for placing the virtual camera directed toward the above midpoint. Among these candidate positions, the position that allows the machines a and b to be photographed in a state of being most closely aligned without being blocked by obstacles, is determined as the position of the virtual camera. In FIG. 11, a virtual camera 230 is placed at a position that avoids an item 200 serving as an obstacle and allows the machines a and b to be photographed in a state of being most closely aligned, and a slow-motion image is taken. In other words, among the candidate positions at both ends of the broken line forming the largest angle with the straight line 220, a virtual camera is placed at the position that avoids obstacles and allows a scene to be captured, and a slow-motion image is taken. If either of the candidate positions at both ends cannot avoid obstacles and does not allow a scene to be captured, or if there is no obstacle in the case of either candidate position, a slow-motion image is taken from either candidate position. The scene in which the above machine capture is attempted and succeeds or fails (scene displayed in slow motion) may be captured from above (for example, directly overhead) in the virtual space. The presence or absence of obstacles may be determined, for example, by a ray-casting method.

Referring back to FIG. 10, when it is determined to be a success in the machine capture determination, the character A which has boarded the machine b is automatically accelerated for a specified period (for example, 3 seconds) (for example, automatically accelerated with acceleration performance and speed performance exceeding the actual performance values; see FIG. 6) and is set to a machine-capture protection state for a specified period (for example, 4 seconds) during which the machine cannot be captured (see FIG. 10(2-2)). This prevents the machine from being captured by another character immediately after the machine is captured. Instead of, or in addition to, the machine-capture protection state, an attack protection state during which the character does not receive damage from attacks (that is, the actual performance value of durability does not decrease) may be set. Preferably, the machine-capture protection state and/or the attack protection state is maintained for a period that includes at least the duration of the above slow-motion display. This prevents the machine from being captured or attacked during the slow-motion display.

Further, the empty machine a from which the character A has dismounted is placed within a specified range (for example, within 5 meters in the virtual space) in front of the character B which has transitioned to an on-foot state (see FIG. 10(2-3)). Here, “in front of” refers to the direction in which the virtual camera that takes the display image for the player operating the character B which has transitioned to an on-foot state is directed. Alternatively, “in front of” may refer to the direction in which the character B faces. Accordingly, the character B from which the machine has been captured and which has transitioned to an on-foot state can be quickly returned to a state of riding a machine, and, for example, if the player does not desire to cause the character B to board the machine a placed in front, the character B can be caused to move on foot and board another machine. In another exemplary embodiment, a character from which a machine has been captured may be caused to automatically board an empty machine placed in front, without transitioning to an on-foot state. Accordingly, the character from which the machine has been captured can be rapidly returned to the competition.

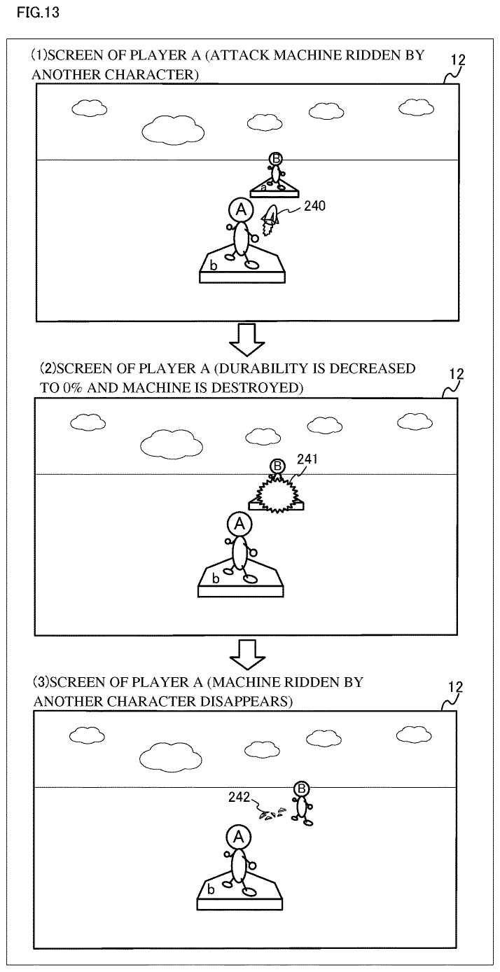

FIG. 13 illustrates a scene in which, in the first game, a character riding a machine attacks another machine being ridden by another character (which can be regarded as the other character itself), reducing the actual performance value of durability (see FIG. 6) of the other machine, and ultimately destroying the other machine. If the attack is successful, the actual performance value of durability of the attacked machine is decreased by a percentage (or numerical amount) corresponding to the attack. For example, when the machine c having an actual performance value of durability shown in FIG. 6 is attacked, the actual performance value of durability is decreased from 72 to 36, which corresponds to a decrease from 50% to 25%. Hereinafter, a case where the character A riding the machine b and operated by the player A attacks the machine a being ridden by the character B operated by the player B, will be specifically described as one example.

In response to a specified operation (attack instruction) performed by the player A, a missile 240 is fired from the machine b toward the machine a (see FIG. 13(1)). If the missile 240 hits the machine a, and the attack becomes successful with the display of an effect 241 showing an explosion, the actual performance value of durability of the machine a (see FIG. 6) decreases, and if this actual performance value decreases to 0 (or below 0), the machine a is destroyed (see FIG. 13(2)). Then, the destroyed machine a becomes wreckage 242, which cannot be boarded by any character, and substantially disappears from the stage of the first game, causing the character B to transition to an on-foot state (see FIG. 13(3)). Alternatively, the wreckage 242 may not necessarily be displayed, and the destroyed machine may completely vanish without leaving any wreckage. Further, a state where characters other than the character that has destroyed the machine cannot board this machine may be set. The actual performance value of durability is also decreased, for example, when a machine falls off the stage while being ridden by a character, or is attacked by a certain non-player character (a mob character or the like). In specified situations in which damage is received (for example, a machine falls off the stage), the actual performance value of durability may be decreased by a specified percentage of the maximum value for the actual performance value of durability (144 in FIG. 6).

### Second Game

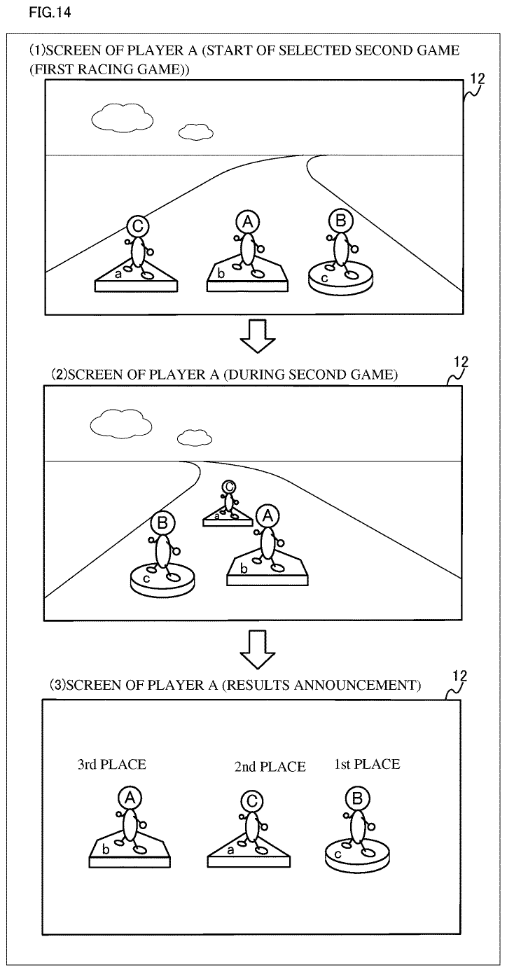

FIG. 14 illustrates the second game which is performed after the first game ends. In FIG. 14, the first race game (one of four types of second games), in which characters can hardly attack each other and which has many straight sections, is shown as an example. As previously described, after the first game ends, each player selects which second game to participate in. The second game is started with each character riding the machine that had been ridden by the character at the end of the first game, and in the second game, each character retains the items that change the actual performance values of the machine and that have been acquired in the first game. That is, the actual performance values at the end of the first game (see FIG. 6) are carried over at the start of the second game. Items other than those that change the actual performance values (for example, missile 240) may not necessarily be carried over to the second game. The actual performance value of durability (see FIG. 6) may be returned to its maximum value (or by a specified percentage thereof) at the start of the second game. A character that had been in an on-foot state at the end of the first game boards a specific machine (for example, a machine whose machine characteristic values are generally lower than those of other machines) and participates in the second game. This specific machine may be a machine a or may be any other type of machine. Alternatively, a character that had been in an on-foot state at the end of the first game may participate in the second game in an on-foot state.

When the first race game is started, the characters operated by the players participating in the first race game are placed at the starting position. In FIG. 14(1), the character C riding the machine a, the character A riding the machine b, and the character B riding the machine c are placed at the starting position.

Thereafter, when the race is started, each character riding the machine moves in response to an operation performed by each player, and the race progresses (see FIG. 14(2)). When the race ends, the result of the first race game, which constitutes the result of this competitive game, is displayed (see FIG. 14(3)).

### Details of Information Processing in Exemplary Embodiment

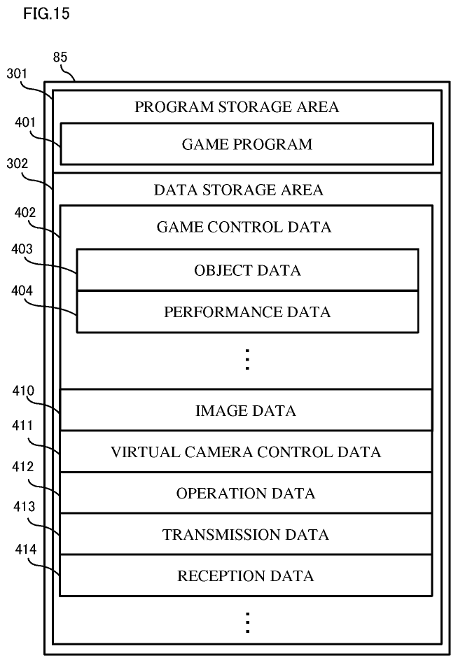

Next, the details of information processing in the exemplary embodiment will be described in detail with reference to FIG. 15 to FIG. 22.

### Data to be Used

Various data to be used in this game processing will be described. FIG. 15 shows an example of data stored in the DRAM 85 of the game system 1. As shown in FIG. 15, at least a program storage area 301 and a data storage area 302 are provided in the DRAM 85. In the program storage area 301, a game program 401 is stored. In the data storage area 302, game control data 402, image data 410, virtual camera control data 411, operation input data 412, transmission data 413, reception data 414, etc., are stored. The game control data 402 includes object data 403 and performance data 404.

The game program 401 is a game program for executing the game processing.

The object data 403 is data of objects to be placed in the virtual space, and is data of objects such as a player character, machines, items, terrains, blocks, rocks, stones, trees, and buildings. In addition, the object data 403 includes data of coordinates (positions), orientations, postures, states, etc., of objects.

The performance data 404 is data regarding the contents described with reference to FIG. 6. For example, the performance data 404 includes data indicating the machine characteristic values of each machine, data indicating the values having undergone the riding-character correction for each player character, data indicating the values having undergone the acquired-item correction for each item, data indicating the current durability ratio, data indicating the actual performance values in a state where the player character is riding a machine, etc.

The image data 410 is image data of backgrounds, virtual effects, etc.

The virtual camera control data 411 is data for controlling the movement of the virtual camera placed in the virtual space. Specifically, the virtual camera control data 411 is data for designating the position, the orientation, the angle of view, the imaging direction, etc., of the virtual camera.

The operation input data 412 is data indicating the contents of operations performed on the left controller 3 and the right controller 4. The contents of the operation input data are updated at specified cycles on the basis of signals from the left controller 3 and the right controller 4.

The transmission data 413 is data to be transmitted to another game system 1, and includes at least information for identifying a transmission source and the contents of the operation input data 412. The transmission data 413 includes data (data indicating the coordinates (position), the posture, the state, etc.) regarding the own player character, to be transmitted to other game systems 1 of multiplayer opponents (or to a server), etc.

The received data 414 is transmission data received from other game systems 1 and stored so as to be able to be identified for each of the other game systems 1 (i.e., for each transmission source). The received data 414 includes data (data indicating the coordinates (positions), the postures, the states, etc.) regarding other player characters, etc., received from the other game systems 1 of the multiplayer opponents (or from the server).

In addition, various data to be used in the game processing are stored as necessary in the DRAM 85.

### Details of Game Processing

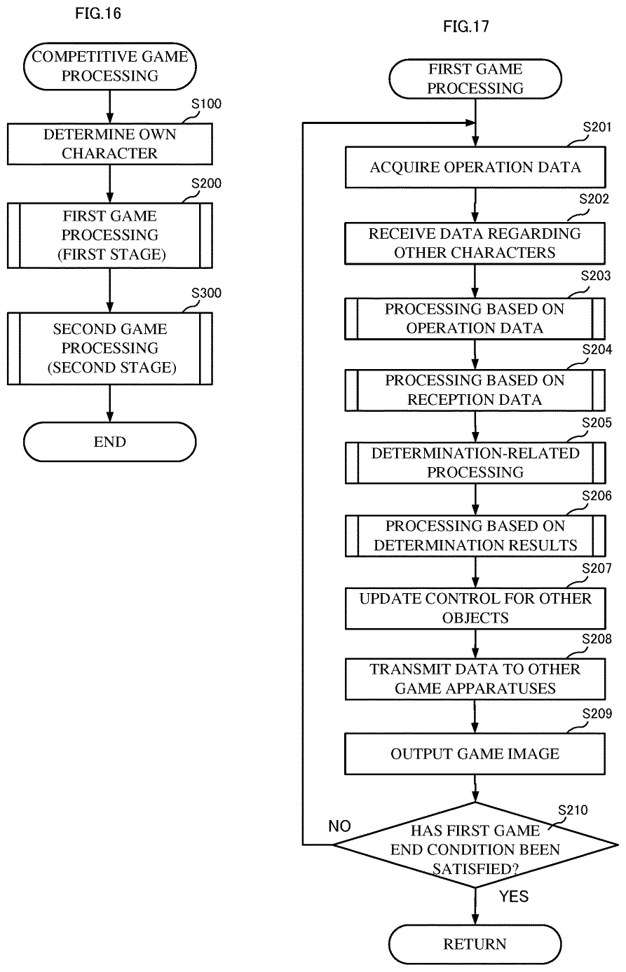

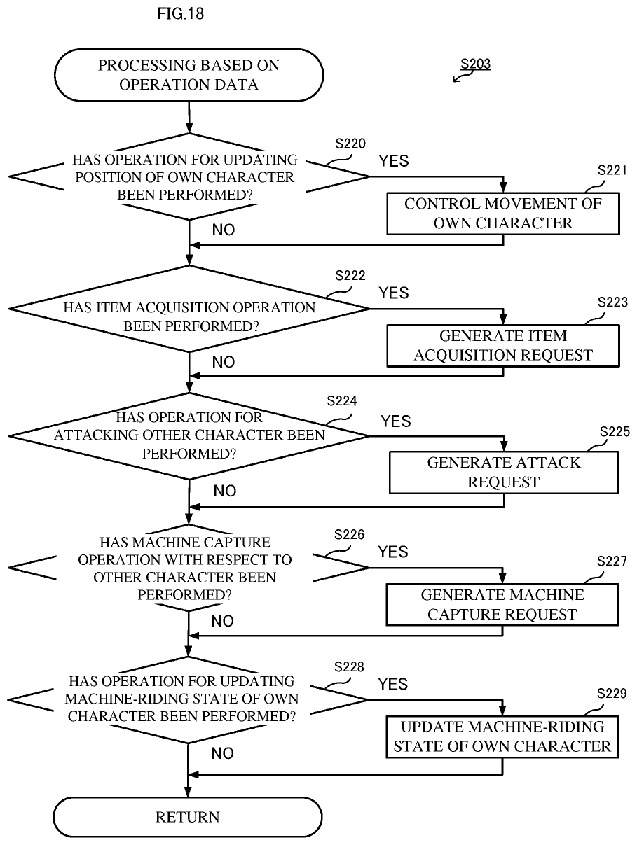

Next, the details of the game processing according to the exemplary embodiment will be described with reference to flowcharts. FIG. 16 to FIG. 22 are each an example of a flowchart showing the details of the game processing according to the exemplary embodiment. In the following description, processing characteristic to the exemplary embodiment will be described, and the description for other processing such as rendering processing is omitted. In addition, first game processing and second game processing in FIG. 17 to FIG. 22 are executed at specified intervals (for example, at frame intervals in processing executed every 1/60 second).

When the game processing is started and the competitive game is started, competitive game processing in FIG. 16 is started.

In step S100 in FIG. 16, the processor 81 determines the own character selected by the player, based on the operation input data 412. The processor 81 acquires information such as the characters selected by the other players from the other game apparatuses of the multiplayer opponents, based on the reception data 414. Then, the processing proceeds to step S200. In the exemplary embodiment, as one example, it is assumed that multiple game apparatuses with which a multiplayer game is played communicate with each other, generate substantially the same virtual space in synchronization, and progress the multiplayer game.

FIG. 17 to FIG. 21 are each an example of a flowchart of the first game processing in step S200. The first game processing is processing for executing the first game described with reference to FIG. 4 to FIG. 13.

In step S201 in FIG. 17, the processor 81 acquires the operation input data 412. Then, the processing proceeds to step S202.

In step S202, the processor 81 acquires data regarding the other characters of the multiplayer opponents, based on the reception data 414. The data is, for example, data indicating the current positions (coordinates, etc.), the machine-riding states, etc., of the other characters. Then, the processing proceeds to step S203.

In step S203, the processor 81 performs processing based on the operation input data (412). FIG. 18 is an example of a flowchart of the processing in step S203 based on the operation input data.

In step S220 in FIG. 18, the processor 81 determines whether or not an operation for updating the position of the own character has been performed. If the determination result in step S220 is YES, the processing proceeds to step S221, and if the determination result in step S220 is NO, the processing proceeds to step S222.

In step S221, the processor 81 controls the movement of the own character. For example, the processor 81 performs control to move the own character in an on-foot state or in a state of riding a machine (see FIG. 5(1) and FIG. 7(1)). Then, the processing proceeds to step S222.

In step S222, the processor 81 determines whether or not an item acquisition operation has been performed. For example, the processor 81 determines whether or not the own character has entered a specified range of an item by moving or the like. If the determination result in step S222 is YES, the processing proceeds to step S223, and if the determination result in step S222 is NO, the processing proceeds to step S224.

In step S223, the processor 81 generates an item acquisition request. Then, the processing proceeds to step S224.

In step S224, the processor 81 determines whether or not an operation for attacking another character has been performed. If the determination result in step S224 is YES, the processing proceeds to step S225, and if the determination result in step S224 is NO, the processing proceeds to step S226.

In step S225, the processor 81 generates an attack request. Then, the processing proceeds to step S226.

In step S226, the processor 81 determines whether or not a machine capture operation with respect to another character has been performed. For example, as described with reference to FIG. 9, the processor 81 determines whether or not an operation for accelerating the machine being ridden by the own character to cause the machine to come into contact with the machine being ridden by another character in a state of automatically tracking the other character, has been performed. If the determination result in step S226 is YES, the processing proceeds to step S227, and if the determination result in step S226 is NO, the processing proceeds to step S228. In FIG. 18, etc., control related to lock-on cursor display or automatic tracking is not shown.

In step S227, the processor 81 generates a machine capture request. Then, the processing proceeds to step S228.

In step S228, the processor 81 determines whether or not an operation for updating the machine-riding state of the own character has been performed. For example, the processor 81 determines whether or not an operation for causing the own character in an on-foot state to board an empty machine, an operation for causing the own character riding a machine to dismount from the machine and transition to an on-foot state, an operation for causing the own character riding a machine to directly switch to another empty machine, or the like has been performed. If the determination result in step S228 is YES, the processing proceeds to step S229, and if the determination result in step S228 is NO, the processing proceeds to step S204 in FIG. 17.

In step S229, the processor 81 updates the machine-riding state of the own character in accordance with the operation determined in step S228. For example, the processor 81 updates the machine-riding state of the own character by causing the own character in an on-foot state to board an empty machine, causing the own character riding a machine to dismount from the machine and transition to an on-foot state, or causing the own character riding a machine to directly switch to another empty machine (see FIG. 7 and FIG. 8). Then, the processing proceeds to step S204 in FIG. 17.

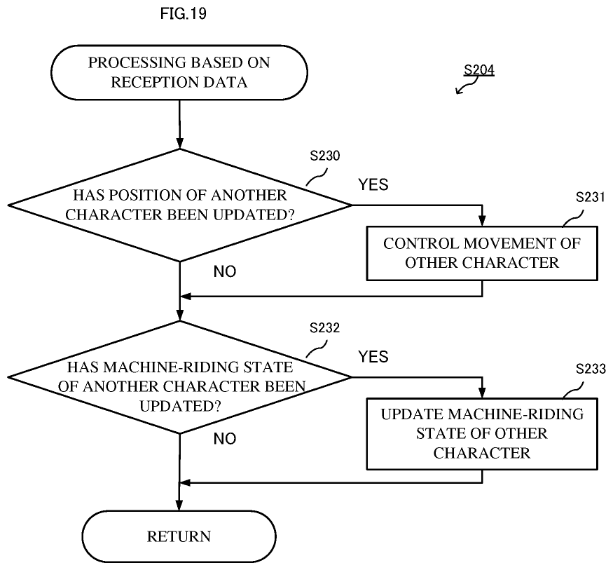

In step S204 in FIG. 17, the processor 81 performs processing based on the reception data (414). FIG. 19 is an example of a flowchart of the processing in step S204 based on the reception data.

In step S230 in FIG. 19, the processor 81 determines whether or not the position of another character has been updated in the game apparatus of a multiplayer opponent. If the determination result in step S230 is YES, the processing proceeds to step S231, and if the determination result in step S230 is NO, the processing proceeds to step S232.

In step S231, the processor 81 controls the movement of the other character. For example, the processor 81 performs control to move the other character in an on-foot state or in a state of riding a machine. Then, the processing proceeds to step S232.

In step S232, the processor 81 determines whether or not the machine-riding state of another character has been updated in the game apparatus of a multiplayer opponent. For example, the processor 81 determines whether or not update in which the other character in an on-foot state is caused to board an empty machine, update in which the other character riding a machine is caused to dismount from the machine, update in which the other character riding a machine is caused to directly switch to another empty machine, or the like has been performed. If the determination result in step S232 is YES, the processing proceeds to step S233, and if the determination result in step S232 is NO, the processing proceeds to step S205 in FIG. 17.

In step S233, the processor 81 updates the machine-riding state of the other character in accordance with the determination in step S232. Then, the processing proceeds to step S205 in FIG. 17.

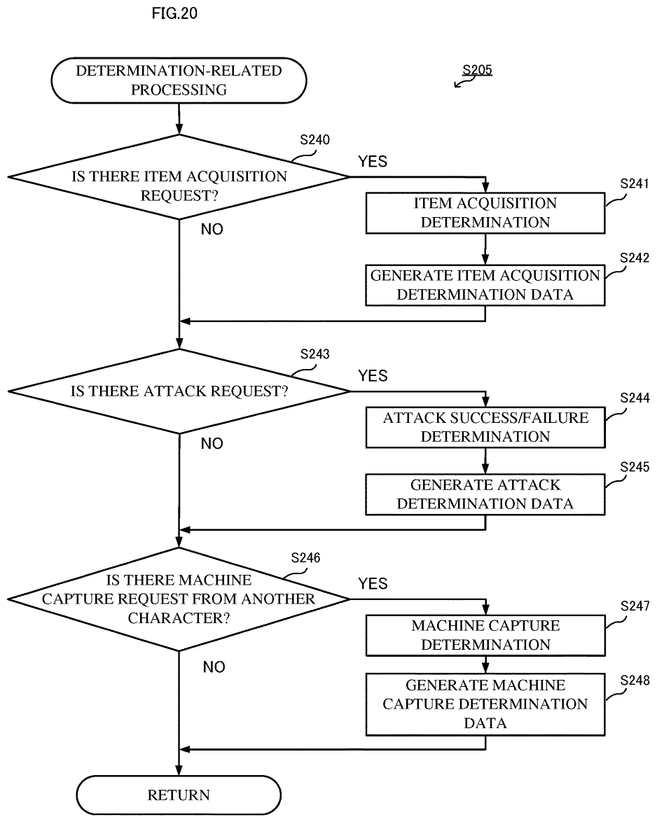

In step S205 in FIG. 17, the processor 81 performs determination-related processing. FIG. 20 is an example of a flowchart of the determination-related processing in step S205.

In step S240 in FIG. 20, the processor 81 determines whether or not an item acquisition request has been generated in step S223, that is, determines whether or not there is an item acquisition request. If the determination result in step S240 is YES, the processing proceeds to step S241, and if the determination result in step S240 is NO, the processing proceeds to step S243.

In step S241, the processor 81 performs an item acquisition determination based on a specified condition. For example, as described with reference to FIG. 5, the processor 81 performs the item acquisition determination based on a specified condition that, if the own character is in a state of riding a machine, it is determined that the item acquisition is successful, and if the own character is in an on-foot state, it is determined that the item acquisition fails. The determination condition for the item acquisition determination may be another condition. Then, the processing proceeds to step S242.

In step S242, the processor 81 generates item acquisition determination data indicating the determination result in step S241. Then, the processing proceeds to step S243.

In step S243, the processor 81 determines whether or not an attack request has been generated in step S225, that is, determines whether or not there is an attack request against another character. If the determination result in step S243 is YES, the processing proceeds to step S244, and if the determination result in step S243 is NO, the processing proceeds to step S246.

In step S244, the processor 81 performs an attack success/failure determination based on a specified condition. For example, if the distance between the own character and the other character is within a specified range (for example, within 20 meters in the virtual space), the processor 81 determines that an attack is successful, with a specified probability (e.g., 10%). Then, the processing proceeds to step S245.

In step S245, the processor 81 generates attack determination data indicating the determination result in step S244. Then, the processing proceeds to step S246.

In step S246, the processor 81 determines whether or not there is a machine capture request from another character. The machine capture request is a machine capture request generated in step S225 in another game apparatus of a multiplayer opponent and is received from the other game apparatus. If the determination result in step S246 is YES, the processing proceeds to step S247, and if the determination result in step S246 is NO, the processing proceeds to step S206 in FIG. 17.

In step S247, the processor 81 performs a machine capture determination based on the performance data 404 (see FIG. 9(4)). For example, as described with reference to FIG. 6, etc., the processor 81 determines whether or not the machine capture is successful, based on a comparison (difference) between the actual performance values of the machine-capturing side and the actual performance values of the side to be captured. Then, the processing proceeds to step S248.

In step S248, the processor 81 generates machine capture determination data indicating the determination result in step S247. Then, the processing proceeds to step S206 in FIG. 17.

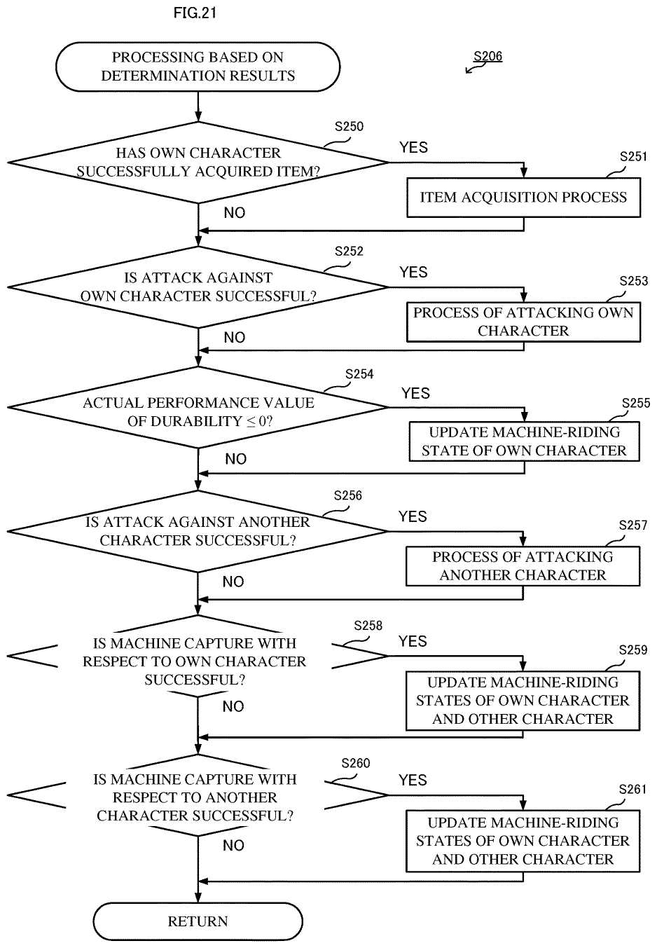

In step S206 in FIG. 17, the processor 81 performs processing based on the determination results. FIG. 21 is an example of a flowchart of the processing in step S206 based on the determination results.

In step S250 in FIG. 21, the processor 81 determines whether or not the own character has successfully acquired an item, based on the item acquisition determination data generated in step S242. If the determination result in step S250 is YES, the processing proceeds to step S251, and if the determination result in step S250 is NO, the processing proceeds to step S252.

In step S251, the processor 81 performs an item acquisition process of causing the own character to acquire the item (see FIG. 5 and FIG. 6). Then, the processing proceeds to step S252.

In step S252, the processor 81 determines whether or not an attack from another character against the own character is successful. This determination is performed based on attack determination data generated in step S245 in another game apparatus of a multiplayer opponent and received from the other game apparatus. If the determination result in step S252 is YES, the processing proceeds to step S253, and if the determination result in step S252 is NO, the processing proceeds to step S254.

In step S253, the processor 81 performs a process for the attack from the other character against the own character (see FIG. 13). Then, the processing proceeds to step S254.

In step S254, the processor 81 determines whether the actual performance value of durability (see FIG. 6) of the own character in a state of riding a machine is 0 (zero) or less. If the determination result in in step S254 is YES, the processing proceeds to step S255, and if the determination result in in step S254 is NO, the processing proceeds to step S256.

In step S255, the processor 81 updates the machine-riding state of the own character. Specifically, the processor 81 destroys the machine being ridden and causes the own character to transition to a state of not riding a machine (on-foot state) (see FIG. 13(2)). Then, the processing proceeds to step S256.

In step S256, the processor 81 determines whether or not an attack from the own character against another character is successful. This determination is performed based on the attack determination data generated in step S245. If the determination result in in step S256 is YES, the processing proceeds to step S257, and if the determination result in in step S256 is NO, the processing proceeds to step S258.

In step S257, the processor 81 performs a process for the attack against the other character (see FIG. 13(1) and (2)). Then, the processing proceeds to step S258.

In step S258, the processor 81 determines whether or not a machine capture by another character against the own character is successful. This determination is performed based on the machine capture determination data generated in step S248. If the determination result in step S258 is YES, the processing proceeds to step S259, and if the determination result in step S258 is NO, the processing proceeds to step S260.

In step S259, the processor 81 updates the machine-riding states of the own character and the other character. Specifically, the processor 81 causes the other character to capture the machine of the own character (i.e., changes the machine ridden by the other character) and causes the own character to transition to a state of not riding a machine (on-foot state) (see FIG. 10). Then, the processing proceeds to step S260.

In step S260, the processor 81 determines whether or not a machine capture by the own character against another character is successful. This determination is performed based on attack determination data generated in step S248 in another game apparatus of a multiplayer opponent and received from the other game apparatus. If the determination result in step S260 is YES, the processing proceeds to step S261, and if the determination result in step S260 is NO, the processing proceeds to step S207 in FIG. 17.

In step S261, the processor 81 updates the machine-riding states of the own character and the other character. Specifically, the processor 81 causes the own character to capture the machine of the other character (i.e., changes the machine ridden by the own character) and causes the other character to transition to a state of not riding a machine (on-foot state) (see FIG. 10). Then, the processing proceeds to step S207 in FIG. 17.

In step S207 in FIG. 17, the processor 81 performs update control for objects other than the own character and the other character. For example, the processor 81 performs processing such as deleting the items that have been acquired by the characters from the stage. Then, the processing proceeds to step S208.

In step S208, the processor 81 transmits data for executing multiplayer gameplay, etc., to the other game apparatuses of the other multiplayer opponents. This data may be transmitted to the other game apparatuses via the server or the like. Then, the processing proceeds to step S209.

In step S209, the processor 81 generates and outputs a game image. Then, the processing proceeds to step S210.

In step S210, the processor 81 determines whether or not an end condition for the first game (for example, a condition that a specified execution time of the first game has elapsed) has been satisfied. If the determination result in step S210 is YES, the processing proceeds to step S300 in FIG. 16, and if the determination result in step S210 is NO, the processing returns to step S201.

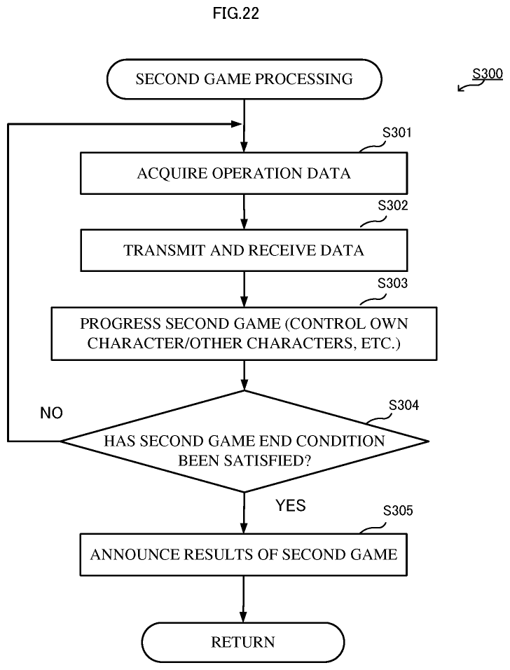

In step S300 in FIG. 16, the processor 81 executes the second game processing. As previously described, the second game is a game played with each character riding the machine that had been ridden by the character at the end of the first game (see FIG. 14), and the characters retain the items that had been acquired at the end of the first game. In addition, there are multiple types of second games, and each player participates in the type of second game selected after the end of the first game. FIG. 22 is an example of a flowchart of the second game processing.

In step S301 in FIG. 22, the processor 81 acquires the operation input data 412. Then, the processing proceeds to step S302.

In step S302, the processor 81 transmits and receives data to and from the other game apparatuses of the multiplayer opponents. For example, the processor 81 transmits data indicating the current position (coordinates or the like) of the own character, the movement state of the own character, etc., to the other game apparatuses of the multiplayer opponents. In addition, the processor 81 receives data indicating the current positions (coordinates or the like) of the other characters, the movement states of the other other characters, etc., from the other game apparatuses of the multiplayer opponents. Then, the processing proceeds to step S303.

In step S303, the processor 81 progresses the second game based on the operation input data 412, the reception data 414, etc. For example, the processor 81 progresses the second game by controlling the own character based on operations performed by the player, and controlling the other characters based on operations performed by the other players who are the multiplayer opponents. Then, the processing proceeds to step S304.

In step S304, the processor 81 determines whether or not an end condition for the second game (for example, a condition that all characters have reached the goal in a race game) has been satisfied. If the determination result in step S304 is YES, the processing proceeds to step S305, and if the determination result in step S304 is NO, the processing returns to step S301.

In step S305, the processor 81 presents the result of the second game (such as a ranking or win/loss) (see FIG. 14(3)). The result of the second game may be regarded as the result of the competitive game. Then, the processing returns to FIG. 16, and the competitive game processing ends.

As described above, according to the exemplary embodiment, by performing machine capture, it is possible to cause the own character riding a machine to board a machine being ridden by another character (see FIG. 9, FIG. 10, etc.).

According to the exemplary embodiment, in the first game, empty machines are placed, and the player character in an on-foot state or in a state of riding a machine can be moved to board any of the empty machines (see FIG. 7, FIG. 8, etc.). Accordingly, the player can cause the own character to board a desired machine.

According to the exemplary embodiment, the machine that had been ridden by a character that has captured a machine from another character is placed as an empty machine in the stage (see FIG. 10, etc.). Accordingly, a decrease in the number of machines present in the stage due to occurrence of machine capture can be prevented, although the number of machines present in the stage of the first game is limited.

According to the exemplary embodiment, a character in an on-foot state can be moved (see FIG. 7, etc.). Accordingly, the character not riding a machine can be moved on foot to board a machine.

According to the exemplary embodiment, a character whose machine has been captured is placed in the stage in an on-foot state (see FIG. 10, etc.). Accordingly, since the character whose machine has been captured temporarily transitions to an on-foot state, the character that has captured the machine can be placed in an advantageous situation.

According to the exemplary embodiment, within a specified range of a character whose machine has been captured, an empty machine that had been ridden by a character that has captured the machine is placed (see FIG. 10, etc.). Accordingly, the character whose machine has been captured can quickly board that empty machine and return to the competition.

According to the exemplary embodiment, the actual performance values (parameters) regarding a character riding a machine are determined according to the machine characteristic values of the machine ridden by the character and the items acquired by the character, and control of the character riding the machine differs depending on these characteristic values (see FIG. 6). Accordingly, it is possible to enjoy the game by strategically making machine selection and performing item acquisition.

According to the exemplary embodiment, when a boarding instruction to cause the own character riding a machine to board another machine being ridden by another character is performed, if the difference between the actual performance values of the own character and the actual performance values of the other character satisfies a specified condition, the machine capture is made successful (see FIG. 6, FIG. 9, FIG. 10, etc.). Accordingly, the player can be allowed to perform machine capture according to the progress of the first game, such as capturing a machine suited for capturing a machine from another player in the first game or capturing a machine that is advantageous for the second game.

According to the exemplary embodiment, the first game is started with each player character riding a machine of the same type (see FIG. 4). Accordingly, since there is no performance difference among the machines at the start of the first game, machine capturing battles at the early stage of the first game can be prevented.

According to the exemplary embodiment, a machine ridden by another character can be attacked and destroyed (see FIG. 12). Accordingly, it is possible to enjoy the first game in a strategic manner.

According to the exemplary embodiment, a character in an on-foot state at the end of the first game is caused to board a specified type of machine, and the second game is started. Accordingly, a character in an on-foot state at the end of the first game can be prevented from being excessively disadvantaged in the second game.

According to the exemplary embodiment, in the second game, characters are made to compete with each other in a competitive format determined based on an operation input performed by the player among a plurality of competitive formats (a racing-type game, a battle-type game, etc.). Accordingly, the player can select the competitive format (rules) of the second game, and, in the first game, can capture a machine that is advantageous for the selected competitive format, from another character.

According to the exemplary embodiment, for a specified period after the machine of another character is captured, the movement speed of the own character after the capture is increased (see FIG. 10). Accordingly, attacks or machine capture by the other character immediately after the machine is captured can be prevented.

According to the exemplary embodiment, for a specified period after the machine of another character is captured, a machine-capture protection is set to restrict the machine from being captured (see FIG. 10). Accordingly, machine capture by the other character immediately after the machine is captured can be prevented.

### Modifications

In the above-described exemplary embodiment, an empty machine may appear in or disappear from the stage during the first game.

In the first game, an empty machine may not necessarily be placed in the stage, coins placed in the stage may be collected, and the character may be caused to board a machine in exchange for the collected coins.

In the first game, a character not riding a machine may be allowed to capture a machine being ridden by another character.

A character not riding a machine at the end of the first game may start the second game in an on-foot state. Alternatively, a character not riding a machine at the end of the first game may be determined to have lost the competitive game without participating in the second game.

The first game and/or the second game may be a team-based game.

In the first game, machine parts scattered and placed in the stage may be collected to complete a special machine whose machine characteristic values are significantly higher than those of other machines, and a character may be allowed to board that machine.

In the first game, a rideable object not being ridden by any character may autonomously move around the stage. The rideable object may be, for example, an animal object such as a horse, a wolf, or a bird.

In the first game, each character may be unable to move while being in an on-foot state. In addition, when a machine being ridden by a character is captured or destroyed, the character may automatically board an initial machine (machine a).

In the first game, each character may be able to capture items that have been acquired by another character, by capturing a machine being ridden by the other character.

Machines of the same type (having the same machine characteristic values) may have different appearances. For example, machines of the same type may have different colorings or shapes.

Before the start of the competitive game, option settings may allow the player to set whether to “select” or “not select” a second game from among a plurality of second games.

When “select” is set, players who have selected the same second game are made to play the selected second game. In this case, when a plurality of second games are executed separately within one competitive game, a plurality of winners may occur for the one competitive game. Alternatively, all players may participate in one second game determined by a majority vote of the players. Alternatively, when “select” is set, each player may select a second game in which the player wishes to participate, and all participating players may participate in one second game determined by a lottery conducted in accordance with the number of players who selected each second game (that is, a lottery having a winning probability corresponding to the number of players who selected each second game). Further, if a second game selected by a player is not selected by any other player, the player may be determined to be a winner of the second game without playing the second game. Further, a player rating (for example, a numerical value indicating the player's skill level) may be updated in accordance with a result of the competitive game (second game).

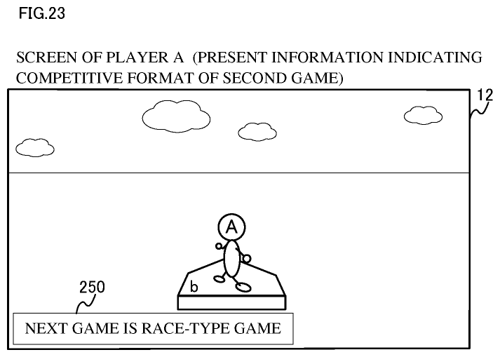

On the other hand, when “not select” is set, a competitive format of the second game (for example, racing-type, battle-type, or the like) may be randomly determined by a lottery or the like at a timing before the first game ends. Information indicating the determined competitive format (for example, racing-type, battle-type, a course type in the case of a racing-type game, or a stage type in the case of a battle-type game) may then be displayed and presented on the display of each player or the like. Thereafter, in the second game having the determined competitive format, the characters of the respective players may compete with each other. FIG. 23 illustrates an example in which information indicating the competitive format of the second game is presented (announced in advance) during progress of the first game. In FIG. 23, a text display 250 indicating “The next game is a racing-type game” is displayed. The information indicating the competitive format may be presented before the start of the first game. Further, when “not select” is set, one second game to be executed may be randomly determined by a lottery or the like at a timing before the first game ends. Information indicating the determined second game or the competitive format of the determined second game may be displayed on the display of each player or the like. The information indicating the competitive format is not limited to the above, and may be a hint of the second game to be executed. For example, the hint may be “The next game may be advantageous if speed performance is high” or “The next game is not a racing-type game”.

Further, even when “select” is set, information indicating the competitive format of the second game may be presented. For example, when “select” is set, each player may be able to select a category of second game in which the player participates (a racing-type category, a battle-type category, or the like), and at a timing before the first game ends, hints respectively indicating a plurality of second games included in the selected category may be presented. For example, when a racing-type category including a first racing game and a second racing game is selected, respective hints for the first racing game and the second racing game may be presented. Alternatively, for example, when the racing-type category including the first racing game and the second racing game is selected, a hint for either one of the first racing game or the second racing game may be presented.

Further, one second game may be automatically selected from among a plurality of second games by a lottery or the like. Alternatively, only one second game may be prepared, and that second game may be executed.

Further, the riding-character correction and/or the acquired-item correction may include correction that decreases machine characteristic values. For example, in FIG. 6, the turning performance in the riding-character correction may be “−20%”. For example, in FIG. 6, correction for durability in the riding-character correction may be “×0.9”. For example, in FIG. 6, the defense performance of an item A in the acquired-item correction may be “−20%”.

Further, in the riding-character correction and/or the acquired-item correction, correction that increases a maximum value for a machine characteristic value may be performed. For example, in FIG. 6, as the riding-character correction, by increasing the maximum value for durability which is a machine characteristic value from 100% to 120%, an amount of durability (50%) which is a machine characteristic value is increased by 20%.

In an information processing system including a terminal-side apparatus and a server-side apparatus capable of communicating therewith via a network, at least some of the series of processes described above may be executed by the server-side apparatus. The server may be composed of a plurality of information processing apparatuses, and the processes may be executed by the plurality of information processing apparatuses in a shared manner.

While the exemplary embodiments and modifications have been described above, it is to be understood that the above description is, in all aspects, merely an illustrative example, and is not intended to limit the scope thereof. In addition, it is to be understood that various improvements and changes can be made to the exemplary embodiments and modifications.

What is claimed is:

1. One or more non-transitory computer-readable storage media having stored therein instructions that, when executed, cause one or more processors to perform operations comprising:
in response to a start instruction for a competitive game based on an operation input, sequentially executing a first game and a second game that is executed after end of the first game;
in the first game,
moving, in a game stage, each participating character riding any of rideable objects having performance different by type among a plurality of participating characters participating in the competitive game, including a first participating character controlled based on an operation input, in a state of riding the rideable object,
when a first boarding instruction with respect to a first rideable object not being ridden by any of the plurality of participating characters is performed based on an operation input, causing the first participating character to board the first rideable object, and
when a second boarding instruction with respect to a second rideable object being ridden by a second participating character among the plurality of participating characters is performed based on an operation input, causing the second participating character to transition to a state of not riding the second rideable object, and causing the first participating character to board the second rideable object; and
in the second game,
causing each participating character riding any of the rideable objects at the end of the first game, among the plurality of participating characters, to board a rideable object that had been ridden by said participating character at the end of the first game, and causing the plurality of participating characters to compete with each other.

2. The one or more non-transitory computer-readable storage media according to claim 1, wherein the operations further comprise determining a win/loss or a ranking among the plurality of participating characters in the competitive game in accordance with a result of the second game.

3. The one or more non-transitory computer-readable storage media according to claim 1, wherein the operations further comprise, in the first game, moving the plurality of participating characters in the game stage in which a rideable object not being ridden by any of the plurality of participating characters is placed.

4. The one or more non-transitory computer-readable storage media according to claim 3, wherein the operations further comprise, in the first game, when the first participating character riding a third rideable object is caused to board the second rideable object being ridden by the second participating character in response to the second boarding instruction, placing the third rideable object in the game stage as a rideable object not being ridden by any of the plurality of participating characters.

5. The one or more non-transitory computer-readable storage media according to claim 4, wherein the operations further comprise, in the first game, moving the first participating character not riding any of the rideable objects, based on an operation input.

6. The one or more non-transitory computer-readable storage media according to claim 5, wherein the operations further comprise, in the first game, when the first participating character is caused to board the second rideable object being ridden by the second participating character in response to the second boarding instruction being performed, placing the second participating character, which had ridden the second rideable object, in the game stage in a state of not riding any of the rideable objects.

7. The one or more non-transitory computer-readable storage media according to claim 6, wherein the operations further comprise, in the first game, when the first participating character riding the third rideable object is caused to board the second rideable object being ridden by the second participating character in response to the second boarding instruction being performed, placing the second participating character and the third rideable object in the game stage such that the third rideable object is located within a specified range based on a position of the second participating character.

8. The one or more non-transitory computer-readable storage media according to claim 1, wherein the operations further comprise, in the first game:
causing the first participating character to acquire an in-game item based on an operation input;
determining a game parameter of the first participating character in accordance with the acquired in-game item and performance of a rideable object to be ridden by the first participating character; and
performing control of the first participating character based on an operation input differently in accordance with the determined game parameter.

9. The one or more non-transitory computer-readable storage media according to claim 8, wherein the operations further comprise, in the second game, controlling the first participating character based on the game parameter of the first participating character at the end of the first game.

10. The one or more non-transitory computer-readable storage media according to claim 8, wherein the operations further comprise, in the first game, when the second boarding instruction to cause the first participating character to board the second rideable object being ridden by the second participating character is performed, causing the first participating character to board the second rideable object if a difference between a first game parameter of the first participating character and a second game parameter of the second participating character satisfies a specified condition.

11. The one or more non-transitory computer-readable storage media according to claim 10, wherein the operations further comprise starting the first game in a state where each of the plurality of participating characters rides the rideable object of the same type.

12. The one or more non-transitory computer-readable storage media according to claim 1, wherein the operations further comprise, in the first game, based on an operation input, causing the second participating character to transition to a state of not riding the second rideable object, based on an attack instruction against the second rideable object being ridden by the second participating character being performed, and updating the second rideable object to at least a state where the second participating character is unable to ride the second rideable object.

13. The one or more non-transitory computer-readable storage media according to claim 6, wherein the operations further comprise, in the second game, causing each participating character that was not riding any of the rideable objects at the end of the first game, among the plurality of participating characters, to board the rideable object of a specified type.

14. The one or more non-transitory computer-readable storage media according to claim 1, wherein the operations further comprise, in the second game, causing at least the participating characters that have specified a competitive format based on an operation input among a plurality of competitive formats, to compete with each other in the specified competitive format.

15. The one or more non-transitory computer-readable storage media according to claim 1, wherein the operations further comprise:
randomly determining a competitive format of the second game from among a plurality of competitive formats before the first game ends;
presenting information indicating the determined competitive format of the second game, before the first game ends; and
in the second game, causing the plurality of participating characters to compete with each other in the determined competitive format of the second game.

16. The one or more non-transitory computer-readable storage media according to claim 1, wherein the operations further comprise, in the first game, when the first participating character is caused to board the second rideable object being ridden by the second participating character based on the second boarding instruction being performed, increasing a movement speed of the first participating character for a specified period after the first participating character is caused to board the second rideable object.

17. The one or more non-transitory computer-readable storage media according to claim 1, wherein the operations further comprise, in the first game, when the first participating character is caused to board the second rideable object being ridden by the second participating character based on the second boarding instruction being performed, restricting, for a specified period after the first participating character is caused to board the second rideable object, the first participating character from being caused to transition to a state of not riding the second rideable object, not based on an operation input performed by a user for controlling the first participating character.

18. A game system comprising one or more processors and one or more non-transitory computer-readable storage media having stored therein instructions that, when executed, cause the one or more processors to perform operations comprising:
in response to a start instruction for a competitive game based on an operation input, sequentially executing a first game and a second game that is executed after end of the first game;
in the first game,
moving, in a game stage, each participating character riding any of rideable objects having performance different by type among a plurality of participating characters participating in the competitive game, including a first participating character controlled based on an operation input, in a state of riding the rideable object,
when a first boarding instruction with respect to a first rideable object not being ridden by any of the plurality of participating characters is performed based on an operation input, causing the first participating character to board the first rideable object, and
when a second boarding instruction with respect to a second rideable object being ridden by a second participating character among the plurality of participating characters is performed based on an operation input, causing the second participating character to transition to a state of not riding the second rideable object, and causing the first participating character to board the second rideable object; and
in the second game,
causing each participating character riding any of the rideable objects at the end of the first game, among the plurality of participating characters, to board a rideable object that had been ridden by said participating character at the end of the first game, and causing the plurality of participating characters to compete with each other.

19. A game apparatus comprising one or more processors and one or more non-transitory computer-readable storage media having stored therein instructions that, when executed, cause the one or more processors to perform operations comprising:
in response to a start instruction for a competitive game based on an operation input, sequentially executing a first game and a second game that is executed after end of the first game;
in the first game,
moving, in a game stage, each participating character riding any of rideable objects having performance different by type among a plurality of participating characters participating in the competitive game, including a first participating character controlled based on an operation input, in a state of riding the rideable object,
when a first boarding instruction with respect to a first rideable object not being ridden by any of the plurality of participating characters is performed based on an operation input, causing the first participating character to board the first rideable object, and
when a second boarding instruction with respect to a second rideable object being ridden by a second participating character among the plurality of participating characters is performed based on an operation input, causing the second participating character to transition to a state of not riding the second rideable object, and causing the first participating character to board the second rideable object; and
in the second game,
causing each participating character riding any of the rideable objects at the end of the first game, among the plurality of participating characters, to board a rideable object that had been ridden by said participating character at the end of the first game, and causing the plurality of participating characters to compete with each other.

20. A computer-implemented method comprising:
in response to a start instruction for a competitive game based on an operation input, sequentially executing a first game and a second game that is executed after end of the first game;
in the first game,
moving, in a game stage, each participating character riding any of rideable objects having performance different by type among a plurality of participating characters participating in the competitive game, including a first participating character controlled based on an operation input, in a state of riding the rideable object,
when a first boarding instruction with respect to a first rideable object not being ridden by any of the plurality of participating characters is performed based on an operation input, causing the first participating character to board the first rideable object, and
when a second boarding instruction with respect to a second rideable object being ridden by a second participating character among the plurality of participating characters is performed based on an operation input, causing the second participating character to transition to a state of not riding the second rideable object, and causing the first participating character to board the second rideable object; and
in the second game,
causing each participating character riding any of the rideable objects at the end of the first game, among the plurality of participating characters, to board a rideable object that had been ridden by said participating character at the end of the first game, and causing the plurality of participating characters to compete with each other.
